(19) United States
(12) Patent Application Publication
(10) Pub. No.: US 2008/0175992 A1
(43) Pub. Date: Jul. 24, 2008

(54) Process For Coating Fine Particles With Conductive Polymers

(75) Inventors: Waldfried Plieth, Dresden (DE); Ursula Rammelt, Dresden (DE); Nils Hebestreit, Dresden (DE); Martin Stratmann, Meerbusch (DE); Michael Rohwerder, Dusseldorf (DE); Hans-Jürgen Adler, Pirna (DE); Karin Potje-Kamloth, Dresden (DE); Evelin Jahne, Ottendorf-Okrilla (DE); Andrij Pich, Dresden (DE); Herlbert Domes, Weilmunster (DE); Julia Schneider, Marburg (DE); Grazyna Paliwoda-Probeska, Duisburg (DE)

Correspondence Address: FULBRIGHT & JAWORSKI, LLP, 666 FIFTH AVE, NEW YORK, NY, 10103-3198, US

(73) Assignee: CHEMETALL GMBH, Frankfurt am Main (DE)

(21) Appl. No.: 11/659,141

(22) PCT Filed: Aug. 3, 2005
(86) PCT No.: PCT/EP05/08314

§ 371 Date: Sep. 19, 2007

(30) Foreign Application Priority Data
Aug. 3, 2004 (DE) 10 2004 037 542.9
Aug. 30, 2004 (DE) 10 2004 037 552.6
Jun. 30, 2005 (DE) 10 2005 030 488.5
Jun. 30, 2005 (DE) 10 2005 030 489.3

(51) Int. Cl. B05D 7/02

(52) U.S. Cl. 427/212

(57) ABSTRACT

A process is disclosed for coating fine particles, in which the feed mixture contains: at least one monomer and/or at least one oligomer selected from monomers and/or oligomers of aromatic compounds and/or unsaturated hydrocarbon compounds suitable for forming an electroconductive oligomer, polymer, copolymer, block copolymer or graft copolymer; at least one type of anions which (1) are and/or can be incorporated as doping ions into the structure of the conductive polymer, (2) can be discharged from said structure in the event of a potential fall of the conductive polymer (reduction); and (3) can have an anticorrosive effect in the presence of a metallic surface; at least one type of particles; if necessary, at least one oxidising agent and water and/or at least another solvent. A coating is formed from the feed mixture on the particle surface, the feed mixture being converted by oxidation into a conductive polymer in the presence of at least one type of mobile anti-corrosive anions. Alternatively, the fine particles are coated with a product mixture that contains a conductive polymer.

The invention relates to processes for coating particles, the mixture for the coating operation, the coating produced in this manner, the particles coated with an electrically conductive coating in this manner and the use of the particles coated in this manner.

Many substances from the class of electrically conductive polymers, in particular based on polyaniline, have been known for years. Many chemical systems which include electrically conductive polymers and can be employed without additions of other electrically conductive substances have been developed. In this context, it has been found that various constituents must be added and certain process steps must be carried out in order to achieve a relatively high electrical conductivity. In some uses a massive layer or thin closed layer of conductive polymers, such as e.g. in the corrosion protection of metallic surfaces, has not proved to be suitable.

The introduction of conductive polymers into an organic matrix, however, is difficult without the introduction of particles which, during mixing or wetting by shear forces (often so-called grinding) intensify the mixing and distribution of the conductive polymers in a matrix, since introduction of powders prepared in a pulverulent manner without a core from conductive polymers, which have about the same properties as the coatings of pure conductive polymer, is more expensive and results in a poorer degree of mixing with the constituents of the composition of the organic coating, and since these powders often comprise fibrous adhesive structures, they can easily cake together.

Many types of inorganic and organic particles, in particular pigments, which are employed in the coated state, e.g. coated with an oxidic shell, such as e.g. very many types of pigments, are known in principle.

The application of the mixture according to the invention, which comprises monomers or/and oligomers, which can react to give the conductive polymer, on to or/and into particle cores can present problems, since many organic core materials can be superficially or wholly dissolved by the solvents, since inorganic particles cannot be matched to the properties of the coatings, such as e.g. to the glass transition temperature T_{g} and to the concentration in the mixture, and also optimized chemically in respect of the surface properties, e.g. by crosslinking or grafting, as flexibly as organic particles. Moreover, in inorganic particles the particle size distribution cannot be varied as widely as in organic particles, in particular in respect of the narrow width of the distribution, but also in respect of the particle shape. Furthermore, organic particles are often better matched chemically to organic binders, which are sometimes necessary for the organic binder matrix. On the other hand, inorganic particles are commercially obtainable rather in a platelet, linear or needle form.

In this context, core materials are to be chosen which as far as possible are completely insoluble in the solvents and liquids chosen, such as usually those core materials in particular based on polyacrylate, polycarbonate, polyethylene, polyimide, polystyrene or/and polyurethane, or such as all inorganic particles. In principle, other organic polymeric particles are also possible. The choice on the one hand of the core materials and on the other hand of the solvents which can be used in the coating of organic particles is therefore limited. Since the hardness of the organic cores and their shell is low, it is to be ensured that the coated particles are not destroyed under relatively high shear forces (so-called grinding). In the following, grinding is referred to, without a distinction being made as to whether it is only wetting by shear forces or in fact grinding with comminution.

DE 199 19 261 A1 describes a process in which the surfaces of oxidic particles are treated with a solution of monomers which are known for the formation of conductive polymers, and the monomers are oxidized by reaction with an oxidizing agent, so that the monomers are converted into conductive polymers. The preparation of monomers based on aniline, pyrrole or thiophene is described in the examples. The preparation of the powders is concluded by filtration, washing, extraction with organic solvents and drying. The aim of the process described there is to produce coatings on the oxide particles with an electrical conductivity which can be adjusted. For this, co-ordinated redox solutions are employed to adjust the degree of oxidation of the conductive polymers. However, no corrosion inhibitors are added. The anions contained in the oxidizing agents have no corrosion protection action. The information from DE 199 19 261 A1 on the preparation of the conductive polymer, on the coating operation, on the chemical compositions and on their further processing and use is incorporated specifically into this Application.

The patent applications DE 102004037542, DE 102004037552 and the Applications for foreign countries resulting from them as well as the parallel Application filed at the same Patent Office by the same Applicant under the title “Process for coating metallic surfaces with a corrosion-protecting coating” and the associated Applications in foreign countries are expressly incorporated into this Application, in particular in respect of the types and amounts of the depot substances, of the anions, of the cations, of the matrix substances, of the starting, intermediate and end substances and of the further components added or formed, and in particular in respect of the chemical reactions, the preparation processes and conditions, the individual process steps, the physicochemical phenomena, the conductivities, the potential values, the potential differences, the changes in potential and other properties, the definitions, the subject matter of the claims, the figures, the tables and the uses, the embodiment variants, the examples and the comparison examples.

The Applicant knows of no publication in which even only a small number of types of anions have varied systematically in combination with conductive polymers. Since the preparation of conductive polymer, which is not commercially obtainable in the case of many compounds and therefore must be prepared in-house with effort, and the variation of the preparation conditions is very expensive, systematic variation of educts for the conductive polymer, of anions and oxidizing agents evidently is not worked on in research, in particular not in the case of those based on polypyrrole or polythiophene.

In most studies of the prior art for the preparation and use of conductive polymer, anions—as a rule called a counter-anion or doping anion—are necessarily, due to the preparation conditions, contained in the mixtures in order to maintain the electroneutrality of the conductive polymer during the formation. However, very little is known about the protective action of such anions during use of conductive polymers. A corrosion protection action of the anions in the conductive polymer is rarely reported in the literature. However, in individual experiments a passivation of the metallic surface beforehand is chosen, in which e.g. a sparingly soluble metal oxalate passivating layer is formed solely from oxalate, before the chemical system with the conductive polymer is applied. When e.g. a polyaniline is used, a non-doped polyaniline is conventionally applied with this system and is doped only afterwards, e.g. with phosphoric acid. Prior passivation is always necessary if the conductive polymer is applied electrochemically. The same anion which is used in the passivation is then necessarily present and is simultaneously incorporated during the polymerization of the conductive polymer, as a counter-ion to preserve electroneutrality.

It has now been found that the anions to be added not only ensure the required electroneutrality when they are incorporated into the structure of the conductive polymers, but can also exert a corrosion protection action on a metallic surface if they migrate out of the conductive polymers again. The corrosion protection action already starts in the event of minor damage to the coating, in that these selected anions migrate out of the conductive polymer and migrate to the damage in the protective layer on the metallic surface. The defective metallic surface can thereby be passivated in many cases, especially if it is not too large.

It has moreover now been found that during corrosive attack on metallic surfaces, cathodic delamination usually occurs. Furthermore, it has been found in this context that this cathodic delamination is often preceded by a drop in potential as a release signal.

The release signal occurs generally in the impaired region, because in the usual consumer metals and their alloys, the potential almost without exception has a more negative value there than the redox potential of the usual conductive polymers. As a result, the latter undergo negative polarization and are therefore reduced.

In cathodic delamination, the actual interfacial delamination is preceded by a lowering in potential, during which the potential at the interface already drops in this preliminary stage of delamination from a value at which the usual conductive polymers are in the oxidized state to a lower value, which leads at least partly to a reduction. In this context, at this advanced cathodic front where the polymer adhesion is not yet destroyed, an oxygen reduction also often takes place at the interface, during which free radicals are formed, which destroy the adhesion at the interface and thus finally lead to delamination. At least a blister can also form at a delaminated point.

It has now been found that these effects can be utilized 1. in order to stop further delamination or/and 2. in order to prevent delamination in this early stage, by releasing anions which inhibit this reaction. If the interface has not yet delaminated in this early stage, only small amounts of such anions are needed because of the small free volume of the still largely intact interface.

This chemical system functions in the case of small defects, but cannot passivate defects which are too large, and in this context can even lead to a disaster if the cation transportation rate in the overall system is too high and if too rapidly a progressing reduction e.g. of the organic coating with a content of conductive polymer thereby occurs, since it is a question of matching all the amounts and properties in this chemical system for corrosion inhibition of metallic surfaces. Chromate alone, however, likewise cannot passivate defects which are too large.

In many chemical systems which comprise conductive polymers, an effect based on the release of anions (release effect) is hoped for or presumed, but has also been demonstrated only in rare individual cases. In this context, intercalations of the conductive polymers in a coating could possibly serve as depots for passivating substances, such as e.g. passivating anions. The anions described in this context in the literature are usually not corrosion-inhibiting. However, the utilization of a release effect for a corrosion protection use is only rarely referred to, and then only in vague terms, but to the knowledge of the Applicant has never been demonstrated in practice and has therefore remained a presumption. To the knowledge of the Applicant, however, the triggering of a release effect by a lowering in potential has never been described.

Although corrosion-protecting anions are described in the prior art, the corrosion protection action is largely limited to a passivating action at the local defective areas, and is not described for the region which is just delaminating. In the case of conductive polymers, a distinction is to be made in this context as to whether they are polymerized chemically or electrochemically, since in the case of electrochemical polymerization, the comparatively base metallic surface is always passivated before deposition of the polymer: For example, if oxalate salts are used, the metallic surface is first passivated. To the knowledge of the Applicant, the publications which describe corrosion-inhibiting anions never indicate a release of these anions due to a lowering in potential.

More than a self-healing effect is known only for chromium(VI)-containing coatings which are free from conductive polymers: 1. Passivation of the metallic surface at the defect or even at the damaged area (anodic part reaction), 2. inhibition of the cathodic part reaction (oxygen reduction) in the region which is just delaminating or/and has already delaminated. Nevertheless, hexavalent chromate is known to be harmful such that the proportion of the chromate content for protection of metallic surfaces is decreased drastically for environmental protection reasons. Even chromate, however, can passivate and heal only small and not large-area defects. However, to date no chemical system is known which actually has more than such a self-healing effect in the absence of hexavalent chromate.

There was therefore the object of proposing processes for coating inorganic or/and organic particles with conductive polymers which are also suitable in principle for use in corrosion protection of metallic surfaces. It would be advantageous if the preparation and coating processes could be carried out as simply as possible and without special devices.

It would moreover be particularly advantageous if in fact individual of the chemical systems with conductive polymers in coatings on metallic substrates not only revealed in the event of damage to the coating by a change in potential with a gradient of the electrical field (release of anions; release effect), but were also to have a healing effect (repair effect). However, the healing effect, by which a delaminated area is repaired again, can be hoped for only with a few individual chemical systems and under certain conditions.

The object is achieved by a process for coating inorganic or/and organic particles, in which the particles are present in a mixture or/and are initially formed in this, wherein the mixture is a dispersion, a flowable or kneadable mass, a sol or/and a gel, which is characterized in that the mixture, called educt mixture, comprises:
at least one monomer or/and at least one oligomer—in the following called “educt(s) of the conductive polymers” or merely “educt(s)”
chosen from monomers or/and oligomers of aromatics or/and unsaturated hydrocarbon compounds, such as e.g. alkynes, heterocyclic compounds, carbocyclic compounds, derivatives thereof or/and combinations thereof, in particular from heterocyclic compounds where X═N or/and S, which are suitable for formation of electrically conductive oligomer/polymer/copolymer/block copolymer/graft copolymer therefrom, in particular chosen from unsubstituted or/and substituted compounds based on imidazole, naphthalene, phenanthrene, pyrrole, thiophene or/and thiophenol,
at least one type of anions—optionally at least one salt, one ester or/and at least one acid as a carrier of these anions
   wherein at least one type of anions in the conductive polymer 1. can be incorporated into the structure of the conductive polymer as a doping ion, 2. can also be released again from this structure in the event of a drop in potential of the conductive polymers (reduction) and 3. if a metallic surface is present, can have a corrosion-protecting action—in the following called “mobile corrosion-protecting anions”,
at least one type of particles chosen from clusters, nanoparticles, nanotubes, fibrous, convoluted or/and porous structures, particles having an average particle size in the range of from 10 nm to 10 mm and accumulations thereof, such as agglomerates or/and aggregates, and
water or/and at least one other polar solvent and optionally at least one further solvent, in particular chosen from polar solvents, nonpolar or weakly polar solvents and from solvents which are not liquid at room temperature but can act as solvents at higher temperature,

wherein a coating having a thickness of at least one monolayer is formed from the educt mixture on at least a part of the surfaces of the particles, the coating in particular either substantially consisting of monomers or/and oligomers or comprising at least a substantial content of monomers or/and oligomers, alongside, where appropriate, at least one further component of the educt mixture,

wherein in the dispersion, in the mass, in the sol or gel or—optionally at least after separating off some of the liquid—in an aerosol at least a part of the monomers or/and oligomers is reacted by oxidation chemically with at least one oxidizing agent, electrochemically under an electrical voltage or/and photochemically under the action of electromagnetic radiation, in each case in the presence of at least one type of mobile corrosion-protecting anions at least partly to give at least one oligomer or/and optionally partly or completely to give in each case at least one polymer, copolymer, block copolymer or/and graft copolymer in a mixture comprising water or/and at least one other polar solvent (“product(s)”),

wherein the oligomers, polymers, copolymers, block copolymers or/and graft copolymers formed by this means—in the following called “conductive polymers”—are at least partly electrically conductive or/and become more electrically conductive.

In this context, preferably at least one educt for the preparation of at least one conductive polymer is chosen because its oxidation potential is lower than or equal to the decomposition potential of water or/and at least one other polar solvent in the mixture used for this.

In this context, the release of mobile corrosion-protecting anions and optionally also of adhesion-promoting anions from the conductive, anion-loaded polymer formed takes place preferably not or/and to only a minor extent via a deprotonation reaction, but predominantly or/and entirely via a reduction reaction.

In this context, these anions can be chosen, in particular, from those based on alkanoic acids, arenoic acids, boron-containing acids, fluorine-containing acids, hetero-polyacids, iso-polyacids, iodine-containing acids, silicas, Lewis acids, mineral acids, molybdenum-containing acids, per-acids, phosphorus-containing acids, titanium-containing acids, vanadium-containing acids, tungsten-containing acids, zirconium-containing acids, salts thereof, esters thereof and mixtures thereof.

The mixture according to the invention optionally comprises at least one oxidizing agent, wherein this at least one oxidizing agent can be omitted entirely or in part, in particular if at least one anion simultaneously acts as an oxidizing agent or/and if polymerization is carried out electrochemically or/and photochemically.

The object is also achieved by a process for coating inorganic or/and organic particles, in which the particles are present in a mixture or/and are initially formed in this, wherein the mixture is a dispersion, a flowable or kneadable mass, a sol or/and a gel, which is characterized in that the mixture is a product mixture and comprises:
at least one electrically “conductive polymer” based on an oligomer/polymer/copolymer/block copolymer/graft copolymer,
at least one type of anions—optionally at least one salt, one ester or/and at least one acid as a carrier of these anions—wherein this at least one type of anion in the conductive polymer 1. can be incorporated or/and is at least partly incorporated into the structure of the conductive polymer as a doping ion, 2. can also be released again from this structure in the event of a drop in potential of the conductive polymer (reduction) and 3. if a metallic surface is present, can have a corrosion-protecting action—in the following called “mobile corrosion-protecting anions”,
at least one type of particles chosen from clusters, nanoparticles, nanotubes, fibrous, convoluted or/and porous structures, particles having an average particle size in the range of from 10 nm to 10 mm and accumulations thereof, such as agglomerates or/and aggregates, and
optionally oxidizing agents, water or/and at least one other solvent,

wherein a coating having a thickness of at least one monolayer is formed from the product mixture on at least part of the surfaces of the particles,

wherein the oligomers, polymers, copolymers, block copolymers or/and graft copolymers formed—in the following called “conductive polymers”—are at least partly electrically conductive or/and become more electrically conductive.

In this context, preferably at least one educt for the preparation of at least one conductive polymer is chosen because the oxidation potential of the educt is lower than or equal to the decomposition potential of water or/and at least one other polar solvent in the mixture used for this.

In this context, the release of mobile corrosion-protecting anions and optionally also of adhesion-promoting anions from the conductive polymer formed takes place preferably not or/and to only a minor extent via a deprotonation reaction, but predominantly or/and entirely via a reduction reaction.

No anilines, polyanilines or derivatives thereof which act according to the invention are known to date to the Applicants. It is particularly preferable that the mobile corrosion-protecting anions also 4. have the ability to stop an oxygen reduction in the impaired region at least and the delamination front or/and at a preceding front or/and 5. also to have an adhesion-promoting action, so that a delamination can be at least partly closed again (repair effect).

In the case of polyanilines, the mobile corrosion-protecting anions are not released from the conductive polymer via a reduction reaction. Since the reduction products of the polyaniline are not stable, the reduction reaction is not chosen in the context of the invention. Rather, the deprotonation reaction is chosen instead of the reduction reaction for release of the anions. No conductive polymers based on polyaniline with which this release takes place by a deprotonation reaction are known to the Applicants.

If the oxidation potential of the educt is lower than or equal to the decomposition potential of water or/and at least one other polar solvent in the mixture used for this, this means that the oxidation (=polymerization) of the conductive polymer is concluded without or before it being possible for a decomposition e.g. of water and e.g. for release of hydrogen to occur.

In the context of this Application, the term “dispersion” includes not only suspensions, but also solutions and emulsions.

It has now been demonstrated that, inter alia, molybdate anions were released due to a lowering in potential in the conductive polymer which was in the impaired region, and migrated directly to the defect. Other migration routes can be ruled out with this experimental procedure. A molybdate-containing passivating layer was then formed at the damaged area on the metallic surface and was detected by XPS measurements (x-ray spectroscopy).

Furthermore, a repair effect has now been demonstrated with a scanning Kelvin probe (SKP), FIG. 2 of DE 102004037542 in combination with Example 1 in that publication reproducing measurement results on a strong passivation effect of a damaged region. In FIG. 2, however, numerous measurement curves obtained between the first measurement, which is at a very low corrosion potential, and individual measurement curves from the middle of the measurement series have been omitted. In between there is a very marked increase in potential by approx. 0.3 V, which suggests that the delamination was at least partly stopped at one delaminating area. In comparison with this, FIG. 1 shows the effects which generally occur.

It has now been found that due to the start of the corrosion process at an area of the metal/coating interface, a change in potential with a gradient of the electrical field starts. The release of the anions (release effect), however, takes place only when such a change in potential takes place. Without injury to the coating, without any other impairment to the coating or without any other defect at the metal-coating interface, such as e.g. contamination, the anions incorporated in the conductive polymer are stored and the potentials are constant. The electrode potential is already lowered significantly before and during delamination of the metallic surface and coating such as occurs in the event of damage to the coating.

This lowering in potential leads to a reduction of the conductive polymers, in particular close to the defect, anions having corrosion-protecting, passivating or/and adhesion-promoting properties being released.

The lowering in potential here can preferably have on the one hand at least the values of the potential difference between the redox potential of at least one depot substance (conductive polymer) in the unimpaired state and the corrosion potential of the metallic surface at a defect, so that the development or advance of the delamination can be at least partly counteracted promptly or early on, before severe delamination occurs.

The lowering in potential here can preferably have on the other hand lower values than that between the redox potential of at least one depot substance in the unimpaired state and the corrosion potential of the metallic surface at a defect, in particular at a front preceding the delamination having a change in potential, so that the development or advance of the delamination can be at least partly counteracted promptly or early on, before slight or severe delamination occurs.

The redox potential of the conductive polymer is preferably higher than the passive potential of the particular metallic material which is to be protected from corrosion by a suitable coating. The redox potential is the potential which is established under normal conditions with the existence of corresponding redox pairs having different degrees of doping which are simultaneously present.

The redox potential can primarily be established via the degree of doping, that is to say depending on the type of anions and their amount. By this means, a potential difference can be established in a targeted manner in the particles according to the invention or in the coating. The redox potential of the conductive polymer is preferably established such that it is above the potential of the passivated metallic surface and significantly above the potential of the corroding surface.

The passive potential is the potential at the interface between the metallic surface and water at which a closed stable passivating covering layer is formed on the metallic surface, so that further dissolving of the metal is suppressed.

It is particularly advantageous if the oxidation potential of the anion is higher than the oxidation potential of the educt, because the anion can then simultaneously act as an oxidizing agent.

It is furthermore preferable for at least one depot substance, that is to say at least one conductive polymer, to have a redox potential which renders possible an early release of anions, and for at least one depot substance to have a comparatively low cation transportation rate of the cations from the electrolyte, in particular from the defect or/and the metallic surface.

Preferably, the cation transportation rate of the cations from the electrolyte, in particular from the defect or/and from the metallic surface, into the at least one depot substance is less than 10⁻⁸cm²/s, particularly preferably less than 10⁻¹⁰ cm²/s, very particularly preferably less than 10⁻¹² cm²/s, in particular also less than 10⁻¹⁴ cm²/s.

The term “impaired region” means the region around the defect, which contains, where appropriate, both the defect, the damaged area, and preceding fronts of the change in potential, that is to say where changes to the chemical system have occurred. The “damaged area” designates the defect including the delaminations which may have occurred. A slight delamination occurs in the region of an advanced cathodic front at which the polymer adhesion is not yet destroyed, but oxygen reduction often also takes place at the interface. Severe delamination occurs if additionally so many free radicals are also formed there which destroy the adhesion at the interface, that is to say lead to the actual delamination.

In all cases, on the one hand the anions and on the other hand the coating, in particular at least one depot substance or/and at least one matrix substance, should have ion sizes or pore sizes such that the chosen anions to be released are not or not considerably impeded during migration through the coating, that is to say in particular through the depot substance(s) and through further components, such as e.g. the matrix. A so-called matrix substance is a substance which at least partly forms or could in principle form the matrix of a coating, such as e.g. an organic polymer/copolymer, it being possible for there to be smooth transitions between the matrix and the further components, such as e.g. after film formation.

The mobile corrosion-protecting anions or/and the adhesion-promoting anions optionally also present preferably have a size which renders them capable of migrating out of the conductive polymer in the impaired region with a high mobility in the event of a drop in potential, and in particular of migrating in the direction of the defect. By targeted migration of the anions to the damaged area, a passivation, with which a (further) dissolving of metal is suppressed, and optionally also a repair of the injured area (repair effect) could be achieved in individual chemical systems with conductive polymers. A prerequisite of this migration is that the pore channels are large enough for the migrating anions, where appropriate including their solvate shells. In the chemical reaction at the damaged area, cations are formed during dissolving of the metal, which, together with the anions, can form a local passivating layer in the region of the injured area.

However, practice to date has shown that the real chemical systems with conductive polymers almost without exception allow only relatively low electrical conductivities, and that the repair effects hitherto were not detectable or were so slight that they cannot be used in technical practice. It is therefore particularly preferable to choose a chemical system in which a repair effect occurs, but which evidently can be used only in some embodiments and under certain conditions. Furthermore, efforts are made to optimize the conditions for the formation of a potential gradient (triggering of the release effect) and optionally also for the healing effect (repair effect), so that it can be used technically. Moreover, the delaminated interface should be protected by the chemical system against (more extensive) corrosion.

One advantage of the use of particles having a content of conductive polymer is the diversity of the use of the particles for any desired metallic surfaces or for any desired types of coatings.

Many coatings of entirely or predominantly organic composition and also of chemically different composition could be improved by an addition of conductive polymers: At a low content of electrically conductive constituents, in particular in respect of the antistatic properties of the coating, and at a higher content of such constituents—in particular with an adjustable electrical conductivity, which may be important, for example, for the deposition of lacquer components in an electrical field or optionally also for the electroweldability of metal sheets coated with such layers. In very many uses a higher or even better corrosion protection of metallic surfaces may be obtained.

Particles substantially consisting of conductive polymer, particles comprising conductive polymer or/and particles as cores having a very thin, thin, thick or very thick shell (core-shell particles) of conductive polymer may be helpful for introducing conductive polymers into a mass, dispersion or solution in particulate, thinly liquid or highly viscous form.

### Compositions of the Educt Mixture and of the Product Mixture:

The object is moreover achieved with an educt mixture or product mixture for coating particles having a composition corresponding to claim 49.

The transitions between the educt mixture and the product mixture are often smooth. A considerable content of the conductive polymer can therefore have been formed in the educt mixture or/and the product mixture can still comprise a considerable content of constituents for further formation of conductive polymer.

Preferably, at least one educt is chosen because it can be polymerized in water or/and its oxidation potential is lower than or equal to the decomposition potential of water in the case of a water-containing solvent mixture or in the case of water as the sole solvent.

This educt mixture can also be characterized in that it comprises
optionally at least one monomer or/and at least one oligomer with a content of educt(s) in the range of from 0.001 to 25 or to 20 wt. %,
at least one mobile corrosion-protecting anion or/and at least one salt, one ester or/and at least one acid as a carrier of this anion, with a content of mobile corrosion-protecting anion in the range of from 0.05 to 50 wt. %, calculated as anion(s),
optionally at least one oxidizing agent with a content of oxidizing agents in the range of from 0.05 to 50 wt.%,
at least one type of inorganic or/and organic particles with a content of particles in the range of from 1 to 95 or to 96 wt. %,
wherein all these contents and optionally further additions not mentioned here, but without solvent, give 100 wt. % in total, and
at least one solvent for the educts, for the anions or/and for the oxidizing agents with contents of solvents in the range of from 1 to 5,000 wt. %, stated above 100 wt. %,
wherein the sum of the solids is 100 wt. % when—optionally later—monomer/oligomer or oxidizing agent has been added.

In the process variants section, variants of the addition are discussed, in particular in the case of monomer/oligomer or oxidizing agent, since after the meeting together of monomer/oligomer, anions and oxidizing agent, as a rule the reaction to give the conductive polymer starts.

Educt mixtures having the following composition have proved to be particularly suitable in particular for organic particles, in particular for coating the particles:
optionally 0.001 to 0.5 mol/l of at least one monomer or/and of at least one oligomer of the educt mixture, as long as high concentrations do not lead to agglomerations of the coated particles, preferably 0.01 to 0.2 mol/l, in particular 0.001 to 0.5 wt. %,
0.01 to 1 mol/l of at least one mobile corrosion-protecting anion, optionally at least one salt, one ester or/and at least one acid as a carrier of this anion, preferably 0.1 to 0.8 mol/l, in particular 0.05 to 3 wt. %, in each case calculated as the anion,
optionally at least one oxidizing agent is added in one to five times the amount of the content of educts (=sum of the monomers and oligomers), that is to say preferably 0.01 to 2.5 mol/l, particularly preferably 0.05 to 1.5 mol/l, in particular 0.1 to 3 wt. %, wherein the content of the at least one oxidizing agent is preferably one to five times the contents of monomers and oligomers in some embodiments,
1 to 96 wt. % of inorganic or/and organic particles, preferably of at least one chemical compound, wherein it is to be ensured that the educt mixture and the product mixture formed therefrom also remain stable at a high particle density, that is to say do not agglomerate or agglomerate relatively severely, preferably 1.5 to 60 wt. %, particularly preferably 2 to 50 wt. %, wherein the concentrations are often only up to 20 wt. % in the educt mixture or/and product mixture in the case of organic particles,
wherein all these contents and optionally further additions not mentioned here, but without solvent, give 100 wt. % in total when—optionally later—monomer/oligomer or oxidizing agent has been added, and
at least one solvent for the educts, for the anions or/and for the oxidizing agents with contents in the range of from 2 to 4,000 wt. %, stated above 100 wt. %.

In one embodiment variant, the educt mixture preferably comprises, in particular for inorganic particles,
optionally at least one monomer or/and at least one oligomer with a content of educt(s) in the range of from 1 to 25 wt. %,
at least one mobile corrosion-protecting anion or/and at least one salt, at least one ester or/and at least one acid as a carrier of these anions, in each case calculated as the anion, with a content of mobile corrosion-protecting anions in the range of from 1 to 35 wt. %,
optionally at least one oxidizing agent with a content of oxidizing agents in the range of from 1 to 40 wt. %, and
at least one type of inorganic or/and organic particles with a content of in particular inorganic particles in the range of from 35 to 95 wt. %.

In another embodiment variant, the educt mixture preferably comprises, in particular for organic particles,
optionally at least one monomer or/and at least one oligomer with a content of educt(s) in the range of from 0.5 to 18 wt. %,
at least one mobile corrosion-protecting anion with a content of mobile corrosion-protecting anions in the range of from 0.5 to 35 wt. %,
optionally at least one oxidizing agent with a content of oxidizing agents in the range of from 0.2 to 30 wt. %, and
at least one type of inorganic or/and organic particles with a content of in particular inorganic particles in the range of from 10 to 40 wt. %.

The educt mixture preferably comprises
optionally at least one monomer or/and at least one oligomer with a content of educt(s) in the range of from 2 to 20 wt. %,
at least one mobile corrosion-protecting anion with a content of mobile corrosion-protecting anions in the range of from 2 to 30 wt. %,
optionally at least one oxidizing agent with a content of oxidizing agents in the range of from 2 to 25 wt. %, and
at least one type of inorganic or/and organic particles with a content of in particular inorganic particles in the range of from 15 to 65 wt. %.

The mixture for formation of the coating which comprises conductive polymer on or/and in particles preferably comprises:
in each case at least one oligomer, polymer, copolymer, block copolymer or/and graft copolymer with a content of conductive polymers in the range of from 0.1 to 30 wt. %, wherein the conductive polymer was polymerized predominantly, largely or entirely in water,
at least one type of mobile corrosion-protecting anions with a content of mobile corrosion-protecting anions in the range of from 0.1 to 40 wt. %, wherein these anions can be released from the conductive polymer via a reduction reaction,
optionally at least one oxidizing agent with a content of oxidizing agents in the range of from 0.1 to 30 wt. %, wherein this at least one oxidizing agent can be omitted entirely or in part if at least one anion simultaneously acts as an oxidizing agent,
optionally at least one type of inorganic or/and organic particles with a content of inorganic particles in the range of from 30 to 98 wt. %, which can be coated with conductive polymer,
wherein all these content, including optionally further additions not mentioned here, but without solvent, give 100 wt. % in total, and
at least one solvent for the at least one educt, for the at least one type of anions or/and for the at least one oxidizing agent with contents in the range of from 0.1 to 4,000 wt. %, stated above 100 wt. %.

Preferably, the content of educts has values of in each case about 0, 1, 2, 4, 6, 8, 10, 12, 14, 16, 18, 20 or 22 wt. %. Preferably, the content of mobile corrosion-protecting anions has values of in each case about 2, 4, 6, 8, 10, 12, 14, 16, 18, 20, 22, 24, 26, 28, 30 or 32 wt. %. Preferably, the content of oxidizing agents has values of in each case about 2, 4, 6, 8, 10, 12, 14, 16, 18, 20, 22, 24, 26, 28, 30, 32, 34, 36 or 38 wt. %. Preferably, the content of particles has values of in each case about 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90 or 92 wt. %.

Preferably, the content of educt(s) has values of in each case about 0.05, 0.1, 0.15, 0.2, 0.25, 0.3, 0.35, 0.4 or 0.45 mol/l. Preferably, the content of mobile corrosion-protecting anions has values of in each case about 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95 or 1.00 mol/l. Preferably, the content of oxidizing agents has values of in each case about 0, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1 or 2.2 mol/l.

Preferably, the content of educt(s) is in the range of from 0.1 to 24 wt. %, in the range of from 0.001 to 0.5 wt. %, in the range of from 1 to 25 wt. %, in the range of from 0.5 to 18 wt. %, in the range of from 2 to 20 wt. %, in the range of from 8 to 22 wt. % or in the range of from 0.8 to 18 wt. %, particularly preferably in the range of from 0.1 to 15 wt. %, in the range of from 2 to 12 wt. % or in the range of from 4 to 16 wt. %, very particularly preferably in the range of from 0.3 to 8 wt. %, in the range of from 5 to 14 wt. % or in the range of from 6 to 12 wt. %.

Preferably, the content of oxidizing agent(s) is in the range of from 0.1 to 45 wt. %, in the range of from 0.001 to 0.5 wt. %, in the range of from 0.1 to 3 wt. %, in the range of from 1 to 40 wt. %, in the range of from 0.2 to 30 wt. %, in the range of from 2 to 25 wt. % or in the range of from 0.01 to 38 wt. %, particularly preferably in the range of from 0.1 to 15 wt. %, in the range of from 0.2 to 32 wt. % or in the range of from 2 to 26 wt. %, very particularly preferably in the range of from 0.3 to 28 wt. %, in the range of from 4 to 24 wt. % or in the range of from 5 to 38 wt. %.

Preferably, the content of mobile corrosion-protecting anions or/and of at least one salt, at least one ester or/and at least one acid as a carrier of these anions, in each case calculated as the anion, is in the range of from 0.05 to 3 wt. %, in the range of from 1 to 35 wt. %, in the range of from 10 to 40 wt. %, in the range of from 0.1 to 30 wt. %, in the range of from 5 to 38 wt. %, in the range of from 12 to 42 wt. % or in the range of from 0.1 to 45 wt. %, particularly preferably in the range of from 0.2 to 26 wt. %, in the range of from 0.4 to 42 wt. % or in the range of from 2 to 30 wt. %, very particularly preferably in the range of from 3 to 38 wt. %, in the range of from 5 to 25 wt. % or in the range of from 14 to 36 wt. %. It is frequently advisable to add the content of anions in excess compared with the anion contents which theoretically can be incorporated into the conductive polymer, or about in the content which can be incorporated stoichiometrically.

Preferably, the content of at least one type of inorganic or/and organic particles is in the range of from 1 to 96 wt. %, in the range of from 35 to 95 wt. %, in the range of from 10 to 40 wt. %, in the range of from 15 to 65 wt. %, in the range of from 2 to 80 wt. %. in the range of from 5 to 65 wt. % or in the range of from 1.5 to 48 wt. %, particularly preferably in the range of from 0.8 to 15 wt. %., in the range of from 1.2 to 32 wt. % or in the range of from 2 to 46 wt. %, very particularly preferably in the range of from 1.3 to 18 wt. %, in the range of from 4 to 24 wt. % or in the range of from 5 to 28 wt. %, above all in the range of from 6 to 16 wt. %.

Preferably, the content of solvent(s), stated above the content of solids=100 wt. %, is in the range of from 2 to 4,000 wt. %, in the range of from 1 to 2,500 wt. %, in the range of from 5 to 3,000 wt. %, in the range of from 10 to 800 wt. %, in the range of from 2 to 300 wt. %, in the range of from 20 to 2,500 wt. % or in the range of from 30 to 600 wt. %, particularly preferably in the range of from 1 to 1,500 wt. %, in the range of from 2 to 1,200 wt. % or in the range of from 50 to 600 wt. %, very particularly preferably in the range of from 30 to 400 wt. %, in the range of from 5 to 160 wt. % or in the range of from 5 to 80 wt. %.

Furthermore, a content of at least one adhesion-promoting anion can be added, for example based on phosphorus-containing oxyanion, such as e.g. phosphonate, silane, siloxane, polysiloxane or/and surfactant, preferably with a content in the range of from 1 to 20 wt. %, particularly preferably with a content in the range of from 1.5 to 18 wt. % or in the range of from 2 to 12 wt. % or/and in particular with a proportion of these anions in the sum of all the anions in the range of from 1 to 70 mol %, preferably in the range of from 10 to 50 mol %. In many embodiment variants, however, no adhesion-promoting anion will be added or it will be present only in comparatively small amounts.

The weight ratio of the constituents in the mixture as educt(s) mobile corrosion-protecting and optionally also adhesion-promoting anion: oxidizing agent(s): inorganic particles in some embodiment variants is preferably 1:(0.5 to 30):(0.5 to 10):(0.5 to 8) and particularly preferably 1:(1 to 25):(1 to 8):(1 to 7), wherein educt(s) or oxidizing agent in these ratios can optionally also intermittently be omitted.

The contents of these constituents can be varied within wide limits. The variation depends in particular on the thickness of the coating: Ultra-thin, thin, thick or very thick coatings which have a layer thickness, for example, in the range of from 0.1 to 10 nm, from >1 to 100 nm, from >10 to 1,000 nm (1 μm), from >100 nm to 10 pm or from 0.5 μm to 50 μm can be applied. Constituents of low or high density can also be chosen. Furthermore, the specific surface area of the inorganic particles can also influence very much, such as e.g. in the case of SiO₂ powders which have been prepared by flame hydrolysis.

Furthermore, the educt mixture and optionally also the product mixture formed therefrom can also comprise in each case at least one surfactant, one protective colloid, one acid-trapping agent or/and one complexing agent. At least one additive can be added to the mixture, optionally at least one surfactant, such as e.g. in each case at least one nonionic, anionic or/and amphoteric surfactant, at least one protective colloid, such as e.g. a polyvinyl alcohol, at least one acid-trapping agent, such as e.g. ammonia, or a weak base, such as e.g. an acetate, or/and at least one complexing agent, such as e.g. ammonia, citric acid, EDTA or lactic acid. The content of the at least one surfactant is preferably 0.01 to 1.5 wt. %. The content of the at least one protective colloid, of the at least one acid-trapping agent or/and of the at least one complexing agent is in each case preferably 0.01 to 0.8 wt. %.

The educt mixture becomes depleted in dissolved components of the educt mixture in particular due to the coating of the particles. The concentration of the corresponding dissolved components in the product mixture is therefore correspondingly low.

The conductive polymer formed here in the educt mixture by chemical reaction is then in the so-called product mixture.

Process Variants in the Reaction to Give and Coating with Conductive Polymer:

If required, the particles can be dried or/and heated before the dispersing or before the addition to the educt mixture. A mixture of relatively high water content or only water is preferably employed as the solvent. In a number of variants, however, it is favourable or necessary to add a small addition of organic solvents, in particular at least one alcohol, above all 1 to 10 wt. % of at least one alcohol, such as e.g. ethanol, propanol or/and isopropanol.

The solution, the dispersion, the sol or/and the gel of the educt is advantageously flushed with inert gas, such as e.g. argon or/and nitrogen, before addition to the educt mixture in order by this means to keep out atmospheric oxygen, to achieve a better thorough mixing, to establish a defined atmosphere in the gas phase above the mixture or/and to achieve drying of non-aqueous solvents.

When mixing together the constituents of the educt mixture in the form e.g. of a solution or dispersion which is to serve for coating of the particles, in several embodiment variants it has proved appropriate to add all the constituents, apart from the oxidizing agent, while agitating the mixture.

When mixing together the educt mixture, the inorganic or/and organic particles and the at least one liquid and optionally also the at least one educt are often initially introduced into the mixing vessel. Preferably, all the constituents are in each case added to the mixture in the form of a solution or/and dispersion.

In a preferred embodiment, when mixing together the constituents, the educt mixture is preferably kept free from oxidizing agents until at least a monolayer of the educt or educts has formed on at least a part of the surfaces of the inorganic or/and organic particles, so that at least a monolayer can form, in particular by adsorption, in the first place. This is of advantage in particular for inorganic particles. The monolayer then comprises predominantly or entirely educt(s) and mobile corrosion-protecting anions, the adding on of liquid(s), which is also in principle possible to a relatively large degree by this means, not being taken into account here. The time taken for at least a monolayer to form is usually at least one second, sometimes also at least one minute. Preferably, oxidizing agent, in particular in the form of a solution, is then added only after the formation of at least a monolayer. By this means, the at least one educt together with the at least one mobile corrosion-protecting anion is first added on to the particles, so that a comparatively uniform formation of the coating and in some cases also a higher electrical conductivity of the coating with the conductive polymers which are formed later is achieved than in the case of a different sequence of the mixing together. It is advantageous first to add at least some of the educt on to the particle surfaces, before anions are added. There can be waiting times in between, in particular in the range of from 0.5 to 10 minutes. It is preferable to keep the mixture constantly agitated here.

In a further embodiment, the mixture can also be kept free from the educts of the conductive polymers during mixing together of the constituents until at least a monolayer predominantly or entirely of at least one mobile corrosion-protecting anion and optionally of oxidizing agent(s) has formed on at least a part of the surfaces of the in particular inorganic particles. This would then have the advantage that the monolayer comprises predominantly or entirely anions or/and oxidizing agent, the adding on of liquid(s) not being taken into account here. Preferably only after the formation of at least a monolayer substantially of these anions is at least one educt, in particular in the form of a solution or dispersion, added to the educt mixture. A rather onion-skin build-up of the coating or a coating with a gradient is often thereby formed.

However, at least one mobile corrosion-protecting anion should preferably be added either before addition of the oxidizing agent or before addition of the educt.

At least one electrolyte, such as e.g. at least one salt or/and at least one acid, the anion of which is incorporated into the conductive polymers as a doping ion and which has a corrosion protection action as the anion, can additionally be added to the educt mixture of oxidizing agent and monomer/oligomer for reaction to give the conductive polymer. In this context, the at least one electrolyte, which does not act as an oxidizing agent, is added to the mixture before or during formation of the monolayer or the educt layer on a particle.

However, if all the constituents, apart from the particles, were to be contained in the educt mixture and if the particles were then to be added as the last component, the oxidation of the educts would have already started or progressed a long way. Where appropriate, impairments to the coating, such as e.g. incomplete covering or non-covering of the particles, could then occur.

Preferably, the educt mixture—also before all the further constituents are added—and where appropriate also the product mixture formed therefrom are kept agitated, it being possible for the mixing to be carried out with laminar or/and turbulent flow, with static or/and dynamic mixing or/and also by kneading, spraying or/and atomizing.

Generally, inhomogeneities could otherwise occur without agitation of the mixture, such as e.g. stirring or/and ultrasound treatment. Agitation of the mixture for 1 to 40 minutes, in particular for 5 to 30 minutes, is preferred. Before addition of the coated inorganic particles, it is advisable to redisperse these in a liquid or in the mixture by agitation, such as e.g. stirring for a relatively long time, before the addition in order to distribute the particles homogeneously. They can then also usually be kept distributed merely by agitation of the mixture.

In many cases, a pH is preferably established in the range of from 0.5 to 8, preferably from 1 to 7, in some cases from 2 to 6 or from 4 to 8, the type and the stability ranges of the anions being decisive here for the choice of the concrete pH. Nevertheless, in particular certain oxidizing agents, such as e.g. molybdate or/and tungstate, require an elevated temperature in certain pH ranges. In the case of certain inorganic particles, such as e.g. carbonates and sulfides, however, it is preferable not to work in the more strongly acid range, in order not to destroy the particles, in particular not to work at pH values outside the range of from 5 to 7. On the other hand, it is to be noted that in some cases problems may occur with the conductive polymer, such as e.g. over-oxidation, at pH values of greater than 6 or greater than 7. A lowering of the pH of the mixture moreover has the advantage that the conductivity of the mixture can thereby be increased. In the preparation e.g. of polypyrrole, it is often advantageous to lower the pH of the mixture to values of not more than 3. Nevertheless, when establishing the pH it is to be taken into account whether the pH chosen is suitable or favourable for the preparation of the conductive polymer or of the particles to be coated and, where appropriate, also for the use of the coated particles in a coating, such as e.g. in a lacquer.

The mixing, addition of the oxidizing agent, chemical reaction or/and formation of the coating according to the invention is often carried out at a temperature in the range of from 0 to 60° C., preferably in the range of from 10 to 50° C. It is often possible and advisable to work at room temperature. However, in some embodiment variants, at any stage of mixing and optionally also thereafter up to the formation of the conductive coating—in particular in the coating of inorganic particles—the temperature of the educt mixture can preferably be in the range of from 0° C. up to the boiling point of the lowest-boiling liquid, or only up to the temperature of the formation of an azeotropic mixture, preferably in the temperature range of from 0 to 200° C., particularly preferably in the range of from 5 to 120° C., very particularly preferably in the range of from 10 to 70° C. Advantageously, the temperature chosen is approximately maintained about from the mixing to the finished formation of the coating on the particles.

Coating of the particles in the educt/product mixture to form core-shell particles takes preferably 1 minute to 5 hours, particularly preferably 5 minutes to 4 hours, very particularly preferably 10 minutes to 3 hours, in particular 15 minutes to 2 hours.

Mobile Corrosion-Protecting Anions:

Mobile corrosion-protecting anions in the educt mixture and in the composition for the coating of the product have the task of providing the necessary charges for compensating the charges of the electrophilic centres formed on the polymer chains during oxidation and of providing a corrosion protection action initiated by adsorption on to metal surfaces.

If no anions are added to an educt mixture, the conductive polymer will incorporate into its lattice any anions present in the dispersion, but then cannot incorporate any mobile corrosion-protecting anions. More porous, thinner and less electrically conductive layer are then often formed—if at all—than by a process according to the invention.

When an anion was added in by far the most studies of the prior art on the preparation and use of conductive polymers, the electroneutrality of the conductive polymer was as a rule reached during the formation. Furthermore, certain properties of the conductive polymer are influenced by the anion, such as e.g. the electrical or ionic conductivity and the morphology and work function (oxidation potential). It has now been recognized that a corrosion protection can also be achieved by the anion.

The at least one anion preferably has a water-solubility or a solubility in the at least one polar solvent or solvent mixture of at least 1·10⁻³ mol/l, since otherwise the anion also can no longer be incorporated into the conductive polymer (=salt).

In this context, the at least one mobile corrosion-protecting anion which does not act as oxidizing agent can be added to the mixture before or during formation of the monolayer or of the layer on the particles. However, it is also possible for at least one mobile corrosion-protecting anion which simultaneously acts as an oxidizing agent, such as molybdate or/and tungstate, to be added in addition to or as an alternative to the mobile corrosion-protecting anion(s) which do(es) not have an oxidizing action.

In the process according to the invention, at least one type of the corrosion-protecting mobile anions is preferably at least one based on benzoate, carboxylate, such as e.g. lactate, dithiol, fumarate, complex fluoride, lanthanate, metaborate, molybdate, a nitro compound, such e.g. based on nitrosalicylate, on octanoate, on phosphorus-containing oxyanions, such as e.g. phosphate or/and phosphonate, on phthalate, salicylate, silicate, sulfoxylate, such as e.g. formaldehyde-sulfoxylate, thiol, titanate, vanadate, tungstate or/and zirconate, particularly preferably at least one anion based on a titanium complex fluoride or/and zirconium complex fluoride, in each case as MeF₄ or/and MeF₆, it also being possible for other stoichiometric ratios to occur.

In the process according to the invention, a mixture is preferably employed as the at least one type of corrosion-inhibiting and adhesion-promoting anions, particularly preferably a mixture based on at least one of the abovementioned corrosion-protecting mobile anions and phosphonate, silane, siloxane, polysiloxane or/and surfactant, in particular with at least one complex fluoride, titanate, zirconate, molybdate or/and tungstate.

The anions which can be incorporated oxidatively into the depot substance(s) can be chosen in particular from those based on alkanoic acids, arenoic acid, boron-containing acids, fluorine-containing acids, hetero-polyacids, iso-polyacids, iodine-containing acids, silicas, Lewis acids, mineral acids, molybdenum-containing acids, per-acids phosphorus-containing acids, vanadium-containing acids, tungsten-containing acids, salts thereof and mixtures thereof.

Preferably, an addition of at least one mobile corrosion-protecting anion at the level of from 1 to 33 mol %, based on the contents of polymer unit, is chosen, preferably from 5 to 33 mol %. These amounts added correspond to the degrees of doping of the conductive polymers. On the other hand, these anions can also be added in excess.

At least one type of anions can be chosen in particular because these anions are mobile in water, in at least one other polar solvent or/and in a mixture which also comprises at least one non-polar solvent.

Alongside the at least one mobile corrosion-protecting anion, however, at least one anion without a corrosion protection action or/and without the ability to be able to be incorporated into the structure or/and to be able to migrate out of the structure can also be present. However, the content of such anions often should preferably not be too high compared with the so-called mobile corrosion-protecting anions. In some cases a further anion is also introduced with the oxidizing agent, which is often required for oxidation of the educts to give conductive polymers, such as e.g. with the oxidizing agent peroxodisulfate. However, if e.g. H₂O₂ and Fe^{2+/3+} salt is used as the oxidizing agent, no additional anion is introduced if the Fe^{2+/3+} salt is added in catalytic amounts of usually less than 10⁻⁴ mol/l. In many embodiment variants, the content of anions which belongs to the mobile corrosion-protecting anions which is chosen should be as high as possible in order to achieve a high corrosion protection action.

In the process according to the invention, in particular all types of mobile corrosion-protecting anions are preferably chosen such that these anions are not too large in order not to impair the mobility of these anions in the conductive polymer and in adjacent substances. Preferably, an anion such as e.g. molybdate, which is smaller than, in particular, polystyrenesulfonate, is chosen because the latter is as a rule too large for the mobility and can then be used only as a permanently incorporated anion.

Preferably, the at least one mobile corrosion-protecting anion will have a diameter which is not greater than the average pore size of the pore system of the conductive polymer, this diameter preferably being at least 8% smaller or even at least 15% smaller than the average pore size of the pore system. In this context, the anion can be mobile through a very high content of pores, such as e.g. pore channels in particular in the conductive polymer, and can thereby, under certain circumstances, migrate faster or migrate in the first place. An anion which is very much smaller than the average pore size of the pore system can also migrate with a higher probability unhindered or with little hindrance through the pore system when a potential difference exists due to the gradient of the difference between the redox potential of the conductive polymer and the corrosion potential of the corroding metal.

If coatings of high binder content are prepared in the process according to the invention, the mobile corrosion-protecting anion should have such a small size that its mobility is also not or not substantially hindered in the other constituents of the coating. In the event of a corrosive attack, these anions migrate to the impaired region, which almost always has a lower potential than the intact interface.

Preferably, the at least one mobile corrosion-protecting anion is chosen from anions based on carboxylic acids, hydroxycarboxylic acids, oxycarboxylic acids, dicarboxylic acids, tricarboxylic acids, di- or/and tri-substituted arenecarboxylic acids, meta-, ortho- or/and para-substituted arenecarboxylic acids, arenoic acids containing amino, nitro, sulfone or/and OH groups, sulfonic acids, mineral oxy-acids, boron-containing acids, manganese-containing acids, molybdenum-containing acids, phosphorus-containing acids, phosphonic acids, fluorosilicic acids, silicas, acids having a content of at least one element of the rare earths or/and yttrium, such as e.g. cerium-containing acids, sulfur-containing acids, titanium-containing acids, vanadium-containing acids, tungsten-containing acids, tin-containing acids, zirconium-containing acids, salts thereof, esters thereof and mixtures thereof.

Preferably, the at least one anion is chosen from anions based on alkyl-phosphonic acids, aryl-phosphonic acids, benzoic acid, succinic acid, tetrafluorosilicic acid, hexafluorotitanic acid, hexafluorozirconic acid, gallic acid, hydroxyacetic acid, silicas, lactic acid, molybdic acids, niobium acid, nitrosalicylic acids, oxalic acid, phosphomolybdic acid, phosphoric acid, phosphosilicic acid, phthalic acids, salicylic acid, tantalic acid, vanadic acids, tartaric acid, tungstic acids, salts thereof, esters thereof and mixtures thereof.

The electrical conductivity of the coating to be formed is often increased by the addition of the at least one mobile corrosion-protecting anion, which can assume various valency levels and which is easily converted into other valency levels.

Anions which undergo a change in valency or/and an exchange of ligands (change in coordination) in the impaired region, such as e.g. an exchange of ligands in the case of hexafluorotitanate or/and hexafluorozirconate, can also be incorporated. A change in solubility is advantageously also associated with this, leading to the originally soluble anion precipitating out in the impaired region and forming a corrosion-protecting layer. The change in valency can occur as oxidation or reduction. Such layers are preferably oxide layers or/and layers of sparingly soluble salts. If hexafluorotitanate or/and hexafluorozirconate is used, it has proved to be advantageous if hydrofluoric acid is added to the mixture.

It has now been ascertained in experiments that the at least one mobile corrosion-protecting anion, such as e.g. TiF₆²⁻, ZrF₆²⁻, CeO₄⁴⁻, MnO₄⁻, MnO₄²⁻, MoO₄²⁻, MoO₄⁴⁻, VO₄²⁻, WO₄²⁻ or WO₄⁴⁻, undergoes an exchange of ligands, change in valency or/and change in solubility and forms an oxidic protective layer in the region of the defect or/and in the region of the delamination front. Such anions, like most of complex salts, are particularly advantageous.

In delamination experiments in an N₂ atmosphere it has now been possible to demonstrate that molybdate ions are actually released, driven by the potential, from a conductive polymer based on polypyrrole and migrate to the defect, where the molybdate was determined with XPS.

In the process according to the invention, at least one type of the adhesion-promoting anions is preferably at least one based on phosphorus-containing oxyanions, such as e.g. phosphonate, silane, siloxane, polysiloxane or/and surfactant.

In the process according to the invention, a mixture of at least two types of anions is preferably employed as the at least one type of corrosion-inhibiting or/and adhesion-promoting anions, particularly preferably a mixture based on at least one type of the abovementioned corrosion-protecting mobile anions with at least one type of the abovementioned adhesion-promoting anions, in particular chosen from those based on carboxylate, complex fluoride, molybdate, nitro compound, based on phosphorus-containing oxyanions, such as e.g. phosphonate, polysiloxane, silane, siloxane or/and surfactant, very particularly preferably one based on at least one of the abovementioned corrosion-protecting mobile anions with at least one type of the abovementioned adhesion-promoting anions. In particular, a mixture of anion types chosen from anion types on the one hand based on carboxylate, complex fluoride, molybdate and nitro compound and on the other hand based on phosphorus-containing oxyanions, polysiloxane, silane, siloxane or/and surfactant is employed.

It is particularly preferable to choose anions which form protecting substances analogously to chromate, which protect the impaired region—at least partly—both anodically and cathodically. In this context, anions which can undergo a change in valency or/and complex anions which can dissociate are preferably chosen.

Anions of sub-group elements of higher oxidation levels, such as e.g. 4+ or 6+, in particular oxyanions, are also particularly advantageously added. These can display a particularly high corrosion protection action on a metallic surface to be protected if this is provided with an organic coating which comprises conductively coated particles.

In the case of corrosion-protecting anions, it is advantageous if these form a passivating layer which is as dense as possible and as far as possible closed on the metallic surface with the cations present in the impaired region, such as e.g. the cations dissolved out of the metallic surface during corrosion, the at least one substance formed in the passivating layer not being ionically conductive and being stable at the pH range used at the interface. These substances can be, for example, oxides, hydroxides and phosphates and mixtures thereof.

The electrical conductivity of the coating to be formed is often increased by an increase in the concentration of the at least one mobile corrosion-protecting anion in the conductive polymer. Preferably, the ratio of the content of the at least one anion incorporated in the conductive polymer to the content of educt(s) (=degree of doping) is at least 1 mol %, preferably at least 5 mol %, particularly preferably at least 10 mol %, very particularly preferably at least 15 mol %, in particular at least 20 mol %. Theoretically, 50 mol % would be achievable, but is evidently not achieved in practice.

Oxidizing Agents:

Oxidizing agents in the educt mixture have the task of starting the chain construction, which takes place e.g. by a cationic free radical mechanism, and of maintaining it in spite of consumption. Oxidizing agents are therefore to be over-dosed to the educt mixture as a rule preferably beyond the content of 33 mol %. For the reaction of the at least one educt to give at least one product, anions are required for the electroneutrality of the conductive polymer and oxidizing agents are optionally required for the polymerization. Preferably, at least one oxidizing agent is added, especially if there is not at least one anion also simultaneously acting as an oxidizing agent in the chemical polymerization or/and if the polymerization is not carried out electrochemically or/and photochemically.

The oxidizing agent can be at least one based on H₂O₂, such as e.g. barium peroxide, peracetic acid, perbenzoic acid, permanganic acid, peroxomonosulfuric acid, peroxodisulfuric acid, Lewis acid, molybdic acid, niobic acid, tantalic acid, titanic acid, tungstic acid, zirconic acid, yttrium-containing acid, lanthanide-containing acid, Fe³⁺-containing acid, Cu²⁺-containing acid, salts thereof, esters thereof or/and mixtures thereof.

Oxidizing agents which can be employed are, for example, at least one compound based on acid(s), the salt(s) of which can be in several valency levels, such as e.g. iron salt(s), based on peroxide(s) or/and per-acid(s), such as e.g. peroxodisulfate.

In the case of oxidizing agents which can assume several valencies and can change these more or less easily, a suitable, usually somewhat lower or more mid-range pH is often to be chosen. The pH is in many cases then in the range of from 2 to 6, in particular in the range of from 2 to 4 or from 3 to 5. It is, moreover, important to ensure that the oxidation potential of the oxidizing agent is higher than the oxidation potential of the educt to be oxidized or that it is at least equal to this.

Preferably, the particles which comprise conductive polymers and are added to the composition according to the invention are free or substantially free from oxidizing agents.

Particles as Cores for the Preparation of Core-Shell Particles:

The composition, the contents and the structure of the organic or/and inorganic particles can vary within wide ranges.

The average size of the particles is to be counted in the range down to 0.1 μm average size under a scanning electron microscope with suitable preparation with separate evaluation and counting of the individual parts of agglomerates and with evaluation and counting of aggregates as a large individual particle, while the average size in the particle size range of from 5 nm to smaller than 0.1 μm is to be determined with a laser Doppler anemometer of the Zeta-Sizer type from Malvern Instruments, while electron diffraction is preferred for the determination of still smaller average particle sizes. In this context, for the particles recorded by scanning electron microscopy, as an approximation divisible agglomerates which comprise separable individual particles are evaluated and counted as in each case several individual particles, which can to some extent correspond to the effect of gentle grinding.

The size of the organic or inorganic particles should as a rule not change substantially during the coating operation.

The particles can optionally be precoated, chemically modified or/and physically modified. Thus, for example, in the case of SiO₂ particles, a distinction can be made between acid and basic, hydrophilic and hydrophobic particles.

In this context, the particles are in at least one form chosen from: Substantially in the form of clusters, in each case to an approximation in the form of isometric, fibrous, needle-shaped, platelet-shaped, discus-shaped or/and convoluted particles, as coated or/and filled particles, as hollow particles or/and in sponge-like particles. In each case substantially flatly or linearly constructed barrier particles or coated pigments, such as e.g. coated laminar silicates, are particularly preferred.

In particular, in the case of inorganic clusters, nanoparticles or small particles and those which comprise conductive polymers, it is advantageous to suppress the tendency towards agglomeration by suitable measures, such as e.g. addition of pyrophosphate to an aqueous dispersion, and to disperse them thoroughly.

In particular, if required, before addition of a liquid or before addition to the mixture for the reaction to give conductive polymers or to the composition for coating of metallic surfaces, the inorganic particles, substantially or entirely in the dry state or in a liquid dispersion, can be ground, dried, calcined or/and redispersed.

The layer thickness of the layer of the conductive polymer on the particles can be varied within wide ranges. Preferably, the layer thicknesses or/and the parts inside the particles are in the range of from 1 to 200 nm, particularly preferably in the range of from 2 to 100 nm, above all in the range of from 1 to 40 or from 3 to 80 nm. Under certain circumstances, these layers are made thinner in inorganic particles than in organic particles. Thicker layers are indeed in principle conceivable and possible, but could reach their limits if the coated particles can no longer be dispersed. The layer thickness of these shells depends in particular on the reaction time, the concentration of the educts and the interfaces available between particles and liquid components of the educt mixture.

Advantageously, however, coated inorganic particles, in contrast to coated organic particles, are often redispersed before mixing with the binder-containing matrix, especially if agglomerates or/and aggregates are present. Inorganic particles are suitable as cores for covering with conductive polymers, on the other hand, because they can be introduced e.g. into an organic composition, such as e.g. a lacquer and the like, in a simple manner by mixing or/and gentle grinding.

In each case at least one of the following types of particles comprising conductive polymer can be present in a mixture according to the invention or in a composition for coating metallic surfaces with particles:

1.) typical core-shell particles (coated particles) which are partly or completely coated with conductive polymer, these often being inorganic coated particles,

2.) particles which comprise conductive polymer at least partly in the inside or also in the inside, these often being organic particles which have often been prepared together with the conductive polymer,

3.) conductive polymer which can be shaped or prepared as desired, which is in particulate form and has optionally been formed separate or/and by way of exception not around a particle core, that is to say has not been formed as a coating on particles; conductive polymer can optionally also occur in the particles which are to be coated, in particular also if these are still growing, intergrowing with one another or/and healing,

4.) so-called “adhesion promoter particles” of conductive polymer which has on the molecule at least one chemical group which promotes adhesion, such as e.g. a phosphonate group,

5.) fragments a) of particle shells of conductive polymer or/and b) of particles comprising conductive polymer or/and

6.) particles which are formed separately without particle cores and comprise conductive polymer, and which consist substantially or entirely of conductive polymer.

All such particles can optionally also be incorporated into the coating according to the invention. In the context of this Application, they are all summarized by the term “coated particles” or “coated particles comprising conductive polymer”. The content of these individual particle types can be comparatively low or high. The statements regarding the coating process also apply in a corresponding manner to all these other variants of “coated particles”.

Organic Particles:

In the material of the organic particles, “polymer” is understood as meaning at least one polymer chosen from homopolymer(s), copolymer(s), block copolymer(s) or/and graft copolymer(s). These polymers can consist of dispersible or/and non-dispersible particles. These particles can be used as cores for core-shell particles. During the preparation of the organic particles in particular, the conductive polymer may be partly, largely or completely intercalated in the inside of these particles, such particles here also being regarded as “coated particles” and as core-shell particles in the context of this Application.

In particular, the organic particles substantially consist of the following polymers:

The organic particles comprising conductive polymer are preferably predominantly or entirely those which are chosen from the group consisting of polymers based on styrene, acrylate, methacrylate, polycarbonate, cellulose, polyepoxide, polyimide, polyether, polyurethane, siloxane, polysiloxane, polysilane and polysilazane.

1. Polymer based on styrene, acrylate or/and methacrylate, the last two variants being called (meth)acrylate in the following. In particular, they can substantially consist of (meth)acrylate(s) chosen from (meth)acrylate, butyl (meth)acrylate, hydroxyalkyl (meth)acrylate, glycidyl (meth)acrylate and ethylene glycol (meth)acrylate, or/and substantially styrene or/and substantially substituted styrene in each case independently of one another with substituents such as e.g. hydroxide, alkyl, alkoxy or/and sulfonate.

2. Polymer based on polycarbonate: In particular, they can substantially consist of organic carbonate(s) based on bisphenol A, B, C, F or/and Z and optionally substituted, for example, with alkyl, alkoxy or/and aryl.

3. Polymer based on cellulose: In particular, they can substantially consist of cellulose(s) chosen from alkylcellulose and hydroxyalkylcellulose, optionally substituted with substituents such as e.g. hydroxide, alkyl, alkoxy, carboxylate or/and sulfonate.

4. Polymer based on polyepoxides: In particular, they can substantially consist of epoxide(s) chosen from those which are unsubstituted or/and from those which are substituted by substituents, such as e.g. hydroxide, alkyl, alkoxy or/and sulfonate.

5. Polymer based on polyolefins: In particular they can substantially consist of polyolefin(s) chosen from ethylene(s), propylene(s), isobutylene, butylene(s) and 4-methylpentene or/and from at least one substituted polyolefin with substituents such as e.g. alkyl, amino or/and hydroxyl.

6. Polymer based on polyimides: In particular, they can substantially consist of poly(imides) chosen from unsubstituted or/and from substituted poly(imides) with substituents such as e.g. hydroxide, alkyl, alkoxy or/and sulfonate.

7. Polymer based on polyethers: In particular, they can substantially consist of epoxides chosen from ethylene oxide(s) and propylene oxide(s) or/and substituted epoxides with substituents such as e.g. alkyl, aryl, amino or/and chloride.

8. Polymer based on polyurethanes: In particular, they can substantially consist of polyurethane(s) chosen from unsubstituted or/and from substituted polyurethane(s) with substituents such as e.g. hydroxide, alkyl, alkoxy or/and sulfonate. In particular, they can be prepared via diisocyanates and diols or via diisocyanates and primary/secondary diamines, diols which can be employed being hydroxy-terminated diols, polyesters, polyethers, polycarbonates or/and oligo(meth)acrylates and diamines which can be employed being, in particular, alkyldiamines where n=5 to 12.

9. Polymer based on siloxanes or/and polysiloxanes, also on silicones: In particular, they can substantially consist of unsubstituted or/and substituted siloxanes or/and polysiloxanes with substituents such as e.g. hydroxide, alkyl, alkoxy, amino, mercapto or/and sulfonate.

10. Polymer based on polysilanes or/and polysilazanes: They can substantially consist of unsubstituted or/and substituted polysilanes or/and polysilazanes with substituents such as e.g. hydroxide, alkyl, alkoxy or/and sulfonate. For example, they can substantially consist of poly(cyclohexylmethyl)silane(s), poly(dihexyl)silane(s) or/and poly(phenylmethyl)silane(s), or substantially consist of poly(1,2-dimethyl)silazane(s) or/and poly(1,1-dimethyl)silazane(s).

However, for the coating of organic particles or their preparation together with the preparation of conductive polymer, so that the organic particles formed therefrom often have an increased content of conductive polymer in their inside, cores based on dispersible organic polymers, such as e.g. polyacrylates, polystyrenes, polyurethanes or/and polysiloxanes, are suitable in particular. These polymers can also be treated in a process for coating organic particles with conductive polymer in which the organic particles are first prepared—in particular in the same solution or dispersion or/and in the same sol or gel—and thereafter these organic particles are coated according to the invention, or in which the organic particles and the conductive polymer are prepared substantially simultaneously or simultaneously, so that the particles formed therefrom often have intercalations of conductive polymer in their inside and in some cases also conductive polymer on their surface. This process is preferably a one-pot process or/and a substantially continuous process. In this context, the preparation of the organic particles is preferably based on emulsion polymerization, in particular in the absence of surfactants. The processes, possibilities and products of emulsion polymerization are known in principle. These organic particle polymerized by emulsion polymerization are conventionally in a stable dispersion due to the prior preparation.

In many embodiments it is particularly advantageous to prepare the organic particles together with the conductive polymer. In this context it is possible to prepare particles having defined narrow particle size distributions, having mono- or bimodal particle size distributions or/and particles in which organic polymer and conductive polymer are intimately mixed or intergrown with one another. For example, mono- or bimodal distributions in the range of from 30 to 400 nm in size can be formed here. However, it is also possible first to prepare organic particles which are coated or mixed in the region close to the surface with conductive polymer subsequently or only in a delayed phase.

In the preparation of organic particles it is to be ensured that the formation of the micelles is not relatively severely impaired, which is possible, in particular, due to an unsuitable oxidizing agent, due to ion contents which are too high or/and due to stirring which is too vigorous, since in many embodiments the organic particles here are formed from micelles. Here also, chemical compatibility of the components to be added is to be ensured. The polymerization can also be carried out chemically, electrochemically or/and photochemically here.

In principle, coating of all types of organic particles by at least one coating process with conductive polymers is possible, optionally by encapsulation of particles which are poorly dispersible or non-dispersible. In the context of the section of the text, dispersible here means the possibility of having a stable dispersion of the organic particles in a solution or dispersion or/and in a sol or gel, so that substantially no agglomerations occur.

Inorganic Particles:

Preferably, the inorganic particles substantially consist of at least one inorganic substance, in particular substantially in each case at least one boride, carbide, carbonate, cuprate, ferrate, fluoride, fluorosilicate, niobate, nitride, oxide, phosphate, phosphide, phosphosilicate, selenide, silicate, aluminium-containing silicate, sulfate, sulfide, telluride, titanate, zirconate, at least one type of carbon, at least one rock flour, at least one powder of glass, frit, vitreous material, amorphous material or/and composite material, at least one alloy or/and at least one metal—where the alloy or/and the metal does not already corrode during the preparation of the conductive polymer and forms no local cell—or/and mixed crystals thereof, intergrowths thereof or/and mixtures thereof.

The inorganic particles can substantially consist of at least one substance, in particular substantially in each case at least one alkaline earth metal carbonate, alkaline earth metal titanate, alkaline earth metal zirconate, SiO₂, silicate, such as e.g. aluminium-containing silicate, mica, clay mineral, zeolite, sparingly soluble sulfate, such as barium sulfate or calcium sulfate hydrate, flakes, e.g. based on SiO₂ or/and silicate(s), oxide(s) having a content of aluminium, iron, calcium, copper, magnesium, titanium, zinc, tin or/and zirconium.

Particularly fine-grained particles can be prepared, for example, via a sol or/and a gel, such as e.g. a silica sol. The advantage of coating of a sol lies in the high mobility of the components in spite of high concentrations. Such particles often have an average particle size in the range of from 10 to 120 nm. Because of the fine-grained nature of the particles thereby formed, a particularly uniform distribution of the conductive polymers results, in particular in the case of a thin coating with a shell.

Where appropriate, during the preparation of such inorganic particles the conductive polymer may become intercalated partly, largely or completely in the inside of these particles, such particles also being regarded here as “coated particles” and as core-shell particles in the context of this Application.

In some embodiments, narrower particle size distributions than often occur in inorganic particles are particularly preferred. These can be generated e.g. by mixing various distributions, by sieving or sifting or by grinding.

Inorganic particles which are substantially platelet-shaped, substantially linear or/and substantially needle-shaped in structure are particularly preferred. They can thus also act better as barrier particles.

Inorganic particles can in some cases also be in a stable dispersion, in particular depending on the particle size, concentration, density, electrolyte content etc.

Monomers/Oligomers for the Preparation of Conductive Polymers:

For formation of the conductive polymers, it is necessary to add to the educt mixture monomers or/and oligomers which are capable of being able to be reacted to give conductive polymers. The monomers or/and oligomers are called “educt(s)”. The monomers or/and oligomers are preferably chosen from monomers or/and oligomers of inorganic or/and organic nature chosen from aromatics or/and unsaturated hydrocarbon compounds, such as e.g. alkynes, heterocyclic compounds, carbocyclic compounds, derivatives thereof or/and combinations thereof which are suitable for formation of electrically conductive oligomer/polymer/copolymer/block copolymer/graft copolymer therefrom, particularly preferably unsubstituted or/and substituted heterocyclic compounds where X═N or/and S.

An addition of unsubstituted or substituted compounds based on imidazole, naphthalene, phenanthrene, pyrrole, thiophene or/and thiophenol is particularly preferred.

Generally, the substitution of the monomers or/and oligomers or of the oligomers, polymers, copolymers, block copolymers or/and graft copolymers being formed/formed therefrom can be, in particular, by hydrogen (H), hydroxyl (OH), halogen (Br/Cl/F), alkoxy (O—alkyl), alkyl (CₓH_{y}), carboxy (COH), carboxylate (COOH), amine (NH₂), amino (NH₃), amide (CONH₂), primary ammonium (NRH₃⁺), imine (NH), imide (COHNH), phosphonate (PO₃H₂), diphosphonate, mercapto (SH), sulfone (SO₂H), sulfonate (SO₃H), aryl ((C₆H₅)ₙ) or/and unbranched or branched alkyl chains without or with further substituents, wherein the substituents should preferably not be too large.

Preferably, educt(s) for the preparation of the conductive polymer is/are added to the mixture, at least one educt having a relatively loose molecular structure or/and at least one of the conductive polymers formed having a relatively loose molecular structure, in particular such that this leads to a relatively large average pore size (often as a molecular channel size) of the pore systems of the conductive polymer.

Preferably, this is achieved by using at least one educt having at least one incorporated side chain, such as e.g. an alkyl chain having at least 1 C atom, such as e.g. in the case of incorporation of a CH₃ group, or in particular having at least 2 or at least 4 C atoms or/and at least one ring system, which is formed, in particular, with organic groups, such as e.g. by condensing on of a bridge of an ether which forms a ring system.

The at least one educt can be chosen in particular from unsubstituted or/and substituted compounds based on imidazole, naphthalene, phenanthrene, pyrrole, thiophene or/and thiophenol, and among the unsubstituted educts pyrrole is preferred in particular. Unsubstituted or substituted compounds chosen from monomers or/and oligomers based on bithiophenes, terthiophenes, alkylthiophenes, such as e.g. methylthiophene or/and ethylthiophene, ethylenedioxythiophene, alkylpyrroles, such as e.g. methylpyrrole or/and ethylpyrrole, or/and polyparaphenylene are very particularly preferred. Educts from which substituted dendritic or/and ladder-like polymers can be prepared are particularly preferred. At least one educt is optionally also prepared separately beforehand or/and in rare cases added to the composition for coating metallic surfaces. Conventionally, however, at least one depot substance is added to this composition, but usually in a form free or substantially free from educt(s).

Among the substituted educts, particularly preferably at least one compound is chosen from benzimidazoles, 2-alkylthiophenols, 2-alkoxythiophenols, 2,5-dialkylthiophenols, 2,5-dialkoxythiophenols, 1-alkylpyrroles, in particular having 1 to 16 C atoms, 1-alkoxypyrroles, in particular having 1 to 16 C atoms, 3-alkylpyrroles, in particular having 1 to 16 C atoms, 3-alkoxypyrroles, in particular having 1 to 16 C atoms, 3,4-dialkylpyrroles, in particular having 1 to 16 C atoms, 3,4-dialkoxypyrroles, in particular having 1 to 16 C atoms, 1,3,4-trialkylpyrroles, in particular having 1 to 16 C atoms, 1,3,4-trialkoxypyrroles, in particular having 1 to 16 C atoms, 1-arylpyrroles, 3-arylpyrroles, 1-aryl-3-alkylpyrroles, in particular having 1 to 16 C atoms, 1-aryl-3-alkoxypyrroles, in particular having 1 to 16 C atoms, 1-aryl-3,4-dialkylpyrroles, in particular having 1 to 16 C atoms, 1-aryl-3,4-dialkoxypyrroles, in particular having 1 to 16 C atoms, 3-alkylthiophenes, in particular having 1 to 16 C atoms, 3-alkoxythiophenes, in particular having 1 to 16 C atoms, 3,4-dialkylthiophenes, in particular having 1 to 16 C atoms, 3,4-dialkoxythiophenes, in particular having 1 to 16 C atoms, 3,4-ethylenedioxythiophenes and derivatives thereof. In this context, at least one compound can be chosen on the basis of pyrrol-1-ylalkylphosphonic acid, in particular having 1 to 16 C atoms, pyrrol-1-ylalkylphosphoric acid, in particular having 1 to 16 C atoms, pyrrol-3-ylalkylphosphonic acid, in particular having 1 to 16 C atoms, pyrrole-3-ylalkylphosphoric acid, in particular having 1 to 16 C atoms, 5-alkyl-3,4-ethylenedioxythiophene, in particular having 1 to 12 C atoms, 5-(ω-phosphono)alkyl-3,4-ethylenedioxythiophene and derivatives thereof, in particular having 1 to 12 C atoms, which are prepared, used as the basis for the preparation of the depot substance or added to the composition. The number of C atoms can in each case independently of one another be 1, 2, 3, 4, 5, 6, 7, 8, 9, 10, 11, 12, 13, 14, 15 or/and 16.

Among the substituted educts, very particularly preferably at least one compound chosen from 2-methylthiophenol, 2-methoxythiophenol, 2,5-dimethylthiophenol, 2,5-dimethoxythiophenol, 1-methylpyrrole, 1-ethylpyrrole, pyrrol-1-ylalkylphosphonic acid, in particular having 10 or/and 12 C atoms, pyrrol-1-ylalkyl phosphate, in particular having 12 C atoms, 1-methoxypyrrole, 1-ethoxypyrrole, pyrrol-3-ylalkylphosphonic acid, in particular having 6, 8 or/and 11 C atoms, 3-methoxypyrrole, 3-ethoxypyrrole, 3,4-dimethylpyrrole, 3,4-dimethoxypyrrole, 1,3,4-trimethylpyrrole, 1,3,4-trimethoxy-pyrrole, 1-phenylpyrrole, 3-phenylpyrrole, 1-phenyl-3-methylpyrrole, 1-phenyl-3-methoxypyrrole, 1-phenyl-3,4-dimethylpyrrole, 1-phenyl-3,4-dimethoxypyrrole, 3-methylthiophene, 3-ethylthiophene, 3-hexylthiophene, 3-octylthiophene, 3-methoxy-thiophene, 3-ethoxythiophene, 3-hexoxythiophene, 3-octoxythiophene, 3,4-dimethyl-thiophene, 3,4-dimethoxythiophene, 5-(ω-phosphono)methyl-3,4-dioxythiophene and derivative thereof is prepared, used as a basis for the preparation of the depot substance or added to the composition.

In particular, at least one compound chosen from ethylthiophene, ethylenedioxythiophene, methylthiophene, 3-ethylpyrrole, 3-methylpyrrole, N-ethylpyrrole, N-methylpyrrole, 3-phenylpyrrole and derivatives thereof is prepared, used as the basis for the preparation of the depot substance or added to the composition. Heterocyclopentadiene (HCP), dioxy-3,4-heterocyclopentadiene (ADO-HCP), di- to octoheterocyclopentadiene (OHCP) and benzoheterocyclopentadiene (BHCP) are also particularly preferred.

The conductive polymers of the particles coated according to the invention or the particles with a content of conductive polymer can be attacked chemically by nucleophilic attack if the pH is not suitable for them. Educts having at least one substituent, such as e.g. alkoxy or/and alkyl, in particular in the 3-or/and 4-position, which form conductive polymers which cannot be impaired by nucleophilic attack or deactivation, which can lead to an impairment in the electrical conductivity, are therefore advantageously used. These can be, in particular, educts based on heterocyclic compounds having at least one alkyl chain or/and having at least one ring system. Such educts furthermore are also advantageous because the crosslinkability is thereby limited in an advantageous manner, and because the conductive polymers formed therefrom usually have pore systems having particularly large pore channels. Compounds of which the monomers or/and oligomers can be at least partly dissolve or/and polymerized in water are very particularly preferred. Those which can be at least partly or intermittently polymerized in water or solvent mixtures containing water are advantageous in particular.

It is likewise preferable to add to the mixture for the preparation of the conductive polymer at least one educt which is water-soluble and which preferably is no longer or only slightly water-soluble after its oxidation (=polymerization).

Monomers are used, inter alia, because they can be less expensive or can have a higher solubility and higher diffusion coefficient. Oligomers are used in particular if the corresponding monomer cannot be polymerized and if only the oligomer can be polymerized. Oligomers can often be more reactive than monomers.

Educts in the form of copolymers or/and block copolymers can optionally already be present in the educt mixture in addition to the monomers/oligomers, while graft copolymers conventionally are first formed by further chemical reaction(s) with at least one further organic constituent, such as e.g. with a carboxyl or/and ester group, in particular on the polymer matrix of the coating.

Preferably, at least one educt which is chemically stable in a broad pH range after its polymerization to give the conductive polymer is added. The oxidizing agent used is then preferably also stable at the pH chosen. It is preferable for this pH range to include at least 1 or at least 2 units, that is to say e.g. pH values in the range of from 3 to 4.5.

Conductive Polymers Formed:

From the addition of a content of monomers or/and oligomers (educts) which are suitable for formation of conductive polymers, polymers which are at least partly conductive (=products, depot substance) are formed by the oxidation. If oxidizing agent is added, oxidized educts can be created from educts, and can then polymerize and further groups can be added on to them. Smaller oligomers, e.g. those where, for example, n=8, scarcely or do not show the actions of the conductive polymers. The conductive polymers are electrically neutral in the reduced state. During the oxidation (=polymerization) of the conductive polymers, cations are formed, which can take up corresponding anions. The oxidized state can be established chemically with at least one oxidizing agent, electrochemically or/and photochemically. Preferably, no electropolymerization is carried out, but polymerization is largely carried out only chemically or/and photochemically, in particular only chemically or/and photochemically. Particularly preferably, only or largely only chemical methods are used.

A depot substance can in principle have been polymerized chemically, electrochemically or/and photochemically. Preferably, the at least one depot substance or the composition comprising it is applied chemically or/and mechanically in particular to the particles or to the metallic surfaces. In the case of an electrochemical application, the comparatively baser metallic surfaces must be passivated beforehand, in order to suppress severe dissolving of the metallic substances. Therefore, in the case of electrochemical application corrosion-inhibiting anions must always be added to the solution from which the at least one educt is polymerized, in order first to always form a passivating layer. The conductive polymer formed in this manner therefore automatically contains corrosion-inhibiting anions, but the publications which describe corrosion-inhibiting anions evidently never indicate a release of these anions due to a lowering in potential.

In electrochemical polymerization, the particles must often have a negative zeta potential. The coatings which have been produced on particles by electrochemical polymerization have proved to be of comparatively poor quality. Semiconductive particles, which release defect electrons e.g. during UV irradiation, are often necessary in the case of photochemical polymerization. Here also, the coatings which have been produced on particles by photochemical polymerization have proved to be of comparatively poor quality. Furthermore, the polymer shell could be damaged during UV irradiation. The coatings which are the best in comparison with these have now been produced by chemical polymerization.

The conductive polymers have a salt-like structure, so that anion-loaded conductive polymers can be referred to as salts.

For simplification, the at least one polymer, copolymer, block copolymer or/and graft copolymer is called “polymer” or “conductive polymer” in the following. In the process according to the invention, the at least one depot substance is preferably at least one conductive polymer, in particular at least one conductive polymer based on imidazole, naphthalene, phenanthrene, pyrrole, thiophene or/and thiophenol, above all based on pyrrole or/and thiophene. Conductive polymers based on polyphenylene, polyfuran, polyimidazole, polyphenanthrene, polypyrrole, polythiophene or/and polythiophenylene or those which have been at least partly or intermittently polymerized in water are preferably formed. The particularly preferred conductive polymers include, for example, those based on polypyrrole (PPy), polythiophene (PTH), poly(para-phenylene) (PPP) or/and poly(para-phenylenevinylene) (PPV). The depot substance is prepared beforehand either separately or in a mixture and then added to the composition or/and in rare cases added to the composition as an educt or/and reacted in the composition or/and in the coating to give the depot substance.

In the process according to the invention, preferably at least one depot substance and at least one anion which render possible substantial or complete release of the anions from the depot substance are chosen, as a result of which the cation transportation rate of the cations in particular from the electrolyte or/and from the defect can be lowered significantly, as a result of which in turn the formation of harmful free radicals in the region of the metal/coating interface can be reduced.

Preferably, the conductive polymers prepared or used according to the invention are so thermodynamically stable in the oxidized (=doped) state that they cannot discharge by themselves—even over a relatively long period of time—and that their anions also cannot be released without reduction. These chemical systems then thereby differ from some other depot systems which are not conductive polymers, where the anions can leave the depot substance prematurely.

It is particularly preferable to prepare or/and to add to the mixture at least one polymer which is chosen from compounds based on poly(1-alkylpyrrole) (P1APy), in particular having 1 to 16 C atoms, poly(1-alkoxypyrrole) (P1AOPy), in particular having 1 to 16 C atoms, poly(3-alkylpyrrole) (P3APy), in particular having 1 to 16 C atoms, poly(3-alkoxypyrrole) (P3AOPy), in particular having 1 to 16 C atoms, poly(1-arylpyrrole) (P1ArPy), poly(3-arylpyrrole) (P3ArPy), poly(3-alkylthiophene) (P3ATH), in particular having 1 to 16 C atoms, poly(3-alkoxythiophene) (P3ATH), in particular having 1 to 16 C atoms, poly(3-arylthiophene) (P3ArTH), poly(3-alkylbithiophene), in particular having 1 to 16 C atoms, poly(3,3′-dialkylbithiophene), poly(3,3′-dialkoxybithiophene), poly(alkylterthiophene), poly(alkoxyterthiophene), poly(3,4-ethylenedioxythiophene) (PEDOT) and poly(benzo[b]thiophene (PBTH).

It is particularly preferable to prepare or/and to add to the mixture at least one polymer which is chosen from poly(1-methylpyrrole) (P1MPy), poly(1-methoxypyrrole) (P1MOPy), poly(3-methylpyrrole) (P3Mpy), poly(3-methoxypyrrole) (P3MOPy), poly(1-phenylpyrrole) (P1PhPy), poly(3-phenylpyrrole) (P3PhPy), poly(3-methylthiophene), poly(3-hexylthiophene), poly(3-methoxythiophene), poly(3-hexoxythiophene), poly(3-phenylthiophene), poly(3-methylbithiophene), poly(3-hexyl-bithiophene), poly(3,3′-dimethylbithiophene), poly(3,3′-dihexylbithiophene), poly(3,3′-dimethoxybithiophene), poly(3,3′-dihexoxybithiophene), poly(3-methylterthiophene), poly(3-methoxyterthiophene), poly(5-alkyl-3,4-ethylenedioxythiophene), in particular having 1 to 12 C atoms, poly(isothianaphthene) (P1TN), polyheterocyclopentadiene (PHCP), dioxy-3,4-heterocyclopentadiene (ADO-HCP), di- to octoheterocyclopentadiene (OHCP), poly(3-hexylthiophene) (P3HT), substituted or/and ladder-like poly(para-phenylene) (PPP or LPPP) and substituted or/and ladder-like poly(para-phenylenevinylene) (PPV or LPPV).

The particularly preferred conductive polymers include, inter alia, polypyrrole (PPy), poly(N-methylpyrrole) (PMPy), poly(3-alkylpyrrole) (P3AlPy), poly(3-arylpyrrole) (P3ArPy), poly(isothianaphthene) (P1TN), poly(3-alkylthiophene) (P3AIT), poly(alkyl-bithiophene), poly(alkylterthiophene), poly(ethylenedioxythiophene) (PEDOT), poly(3-arylthiophene) (P3ArT), substituted or/and ladder-like poly(para-phenylenevinylene) (PPV), poly(3-hexylthiophene) (P3HT), poly(3-hexylthiophene) (P3HT), polyphenylene (PP), polyparaphenylenevinylene (PPV), polyheterocyclopentadiene (PHCP), polydioxy-3,4-heterocyclopentadiene (PADO), polybenzoheterocyclopentadiene (PBHCP), polythiophene (PT), poly(3-alkylthiophene) where R=alkyl, such as e.g. methyl, butyl etc. (P3AT), polypyrrole (PPy), poly(isothianaphthene) (P1TN), poly(ethylenedioxythiophene) (PEDOT), alkoxy-substituted poly(para-phenylenevinylene) (MEH-PPV), poly(2,5-dialkoxy-para-phenylenevinylene) (MEH-PPV), ladder-like poly(para-phenylene) (LPPP), poly(paraphenylene sulfide) (PPS) and poly(3-hexylthiophene) (P3HT).

Poly(1,3-dialkylpyrrole), poly(3,4-dialkylpyrrole), poly(3,4-dialkylthiophene), poly(1,3,4-trialkylpyrrole), poly(3,4-dialkoxythiophene), poly(1,3,4-trialkoxypyrrole), poly(2-arylthiophene), in each case independently of one another in particular having 1 to 16 C atoms, and corresponding educts can also be chosen among the polymers. Among the aryl compounds, in particular 1-phenyl, 3-phenyl, 1-biphenyl, 3-biphenyl, 1-(4-azobenzene) or/and 3-(4-azobenzene) compounds can be chosen in particular.

In this context, compounds independently of one another with alkyl chains having 1, 2, 3, 4, 5, 6, 7, 8, 9, 10, 11, 12, 13, 14, 15 or/and 16 C atoms are preferably prepared or used.

Substituents which can be chosen for the educts or/and polymers are, in each case independently of one another, preferably H, OH, O, COOH, CH₂OH, OCH₃, CₙH₂ₙ₋₁, in particular where n=2 to 12, OCₙH₂ₙ₋₁, in particular where n=2 to 12, alkyl, alkoxy, aryl, amine, amino, amide, primary ammonium, imino, imide, halogen, carboxyl, carboxylate, mercapto, phosphonate, S, sulfone or/and sulfonate.

The conductive polymers which are suitable for this are indeed often known in principle, but usually have not yet been described for at least one variant of corrosion protection; where corrosion protection is described for this polymer, however, the corrosion protection does not function on relatively base metallic surfaces without a passivating layer already being present. In individual embodiments, at least one depot substance can also at least partly form a matrix in the composition, in particular close to the metal/coating interface. The least conductive polymers are commercially obtainable.

It is advantageous to employ either a conductive polymer modified by substituents or/and by another base molecule (monomer/oligomer)or/and a conductive copolymer comprising at least two different base molecules (monomers/oligomers) having somewhat different redox potentials in order to vary significantly the redox properties of the depot substance from compound to compound. Alternatively or additionally, correspondingly different depot substances can be mixed with one another. By this means, at least one compound which has the correct level of redox potential for the chemical system, including the metallic surface, can be selected or/and a mixture which comprises various conductive polymers having different redox potentials can be prepared. The redox potential of the depot substance is suitable in particular if it is at least 75 mV, at least 100 mV or at least 150 mV, preferably at least 200 mV or at least 250 mV, very particularly preferably at least 300 mV or at least 350 mV above the corrosion potential of the metallic surface.

Preferably, the average pore size of the conductive oligomer, polymer, copolymer, block copolymer or/and graft copolymer to be formed is increased by establishing a relatively high temperature during the formation of the coating or/and during drying of the mixture, in particular a temperature in the range of from 60 to 200° C. in an inert atmosphere, in air in particular in the range of from 30 to 80° C.

Solvents for the Educt Mixture or Product Mixture:

In some embodiment variants, water can be employed as the sole solvent for the preparation of the conductive polymer. It is advantageous to employ water as one of the solvents in a solvent mixture, the water content making up at least 5 wt. % of the solvent mixture. As a result, working can be simpler and more environment-friendly, and the predominant number of anions can be dissolved. Preferably, a relatively high content of water is employed in the solvent mixture, or only water is employed as the entire solvent, especially since many anions are soluble only in water and often not in organic solvents or not in some organic solvents.

Preferably, only or substantially only water is added as the solvent, or in the case of a solvent mixture as the at least one further solvent added is at least one which is liquid in the temperature range of from −30 to 200° C., particularly preferably in the range of from −10 to 160° C. or very particularly preferably in the range of from 1 to 95° C. In this context, the solvents optionally act substantially selectively and dissolve predominantly or only the educts or predominantly or only the anions and oxidizing agents. It is moreover advantages if the solvents can react chemically with the oxidizing agent only little or not at all, not even at elevated temperature. The solvents conventionally do not, or only slightly, superficially or wholly dissolve the resulting oligomers, polymers, copolymers or/and graft copolymers of the conductive polymers.

Preferably, in the case of a solvent mixture the at least one further solvent added, alongside water, in particular is at least one chosen from more or less polar, dipolar aprotic and dipolar protic liquids. In this context, the polarity and therefore the dielectric constant can be varied within wide ranges. Weakly polar liquids, such as chloroform or/and methylene chloride, or dipolar aprotic liquids, such as acetonitrile or/and propylene carbonate, are employed in particular for the educts with which water cannot be used—in particular for compounds such as e.g. based on thiophenes. Polar protic liquids, such as water or/and alcohols, are usually used for the oxidizing agents and anions. Solvents of relatively low polarity, such as e.g. alcohols, are preferably employed for dissolving the educts, while those of high polarity, such as e.g. water, are preferably used for dissolving the oxidizing agents and salts and for diluting the acids.

Preferably, in the case of a solvent mixture the at least one further solvent added is at least one solvent chosen from acetonitrile, chloroform, methylene chloride, ethanol, isopropanol, methanol, propanol, propylene carbonate and water. Solvent mixtures of water with at least one alcohol, which optionally additionally also comprise at least one further solvent or/and also at least one further liquid which is not a solvent, such as e.g. an oil, are often used.

The use of a solvent mixture of water and at least one organic solvent is also particularly advantageous, since e.g. molybdate is sufficiently soluble at the required concentration almost only with water and since some pyrrole derivatives conventionally are sufficiently soluble at the required concentration only with at least a small addition of at least one water-miscible organic solvent, the content of the at least one organic solvent in the solvent mixture being in particular at least 2 wt. %, preferably at least 6 wt. %, particularly preferably at least 12 wt. %, very particularly preferably at least 18 wt. %, especially even at least 24 wt. %.

The degree of conversion of the educts into the conductive polymers is often of the order of from 85 to 99%, usually in the range of from 88 to 96%.

Product Mixture:

The product mixture in which conductive polymer is formed comprises the same or substantially the same contents of constituents as the educt mixture, if the chemical reactions are disregarded. The same amounts data therefore apply accordingly.

At least one stabilizer which was optionally used in the emulsion polymerization used beforehand can also be added to the product mixture. Preferably, the at least one stabilizer is also at least one ionic or nonionic stabilizer—in particular at least one polymerizable or/and polymerized surfactant, which optionally has emulsifier properties. The stabilizer is particularly preferably chosen from water-soluble polymers based on polyvinyl alcohol, polyvinyl alkyl ether, polystyrenesulfonate, polyethylene oxide, polyalkylsulfonate, polyarylsulfonate, anionic or/and cationic surfactants, quaternary ammonium salts and tertiary amines. They are very particularly preferably chosen from the group consisting of anionic or/and cationic surfactants of alkyl-sulfates and alkylsulfonate, preferably of sodium, in particular having an alkyl chain length in the range of from 10 to 18 C atoms. These water-soluble polymers and surfactants are advantageous for better dispersion of the particles.

The product mixture can optionally comprise substantially no or preferably 0.01 to 5 wt. % of at least one stabilizer for anionic, cationic, steric or/and neutral stabilization of the particles in the educt mixture and in the product mixture formed therefrom, particularly preferably 0.5 to 4 wt. % or 0.05 to 3 wt. %, very particularly preferably 0.1 to 2 wt. %.

Treatment of the Conductively Coated Particles:

Preferably, the product mixture with coated particles is dried by decanting, filtering or/and freeze drying, in particular by spin-drying or centrifuging during filtering, or/and by gas circulation or/and heat, in particular at temperatures of up to 200° C. in an inert atmosphere or preferably of up to 150° C. or of up to 120° C. This is conventionally necessary with coated inorganic particles. The mixture containing liquid(s) is largely or entirely dried by this means. If the coated inorganic particles have been largely separated from liquids e.g. by decanting, filtering or/and drying, the content of solvents is often in the region of about 1, 2, 3, 4, 5 wt. % or often only at contents of up to 10 wt. %. The dried “mixture” is called “conductive powder” in the following. In this form, the coating according to the invention on the particles is stable, electrically conductive in the long term and also chemically and in a further manner physically stable in the long term, as long as nucleophilic attack does not take place, e.g. if used in an unsuitable lacquer system with excessive exposure to heat, such as e.g. above 300° C., or by photochemical degradation, e.g. in the presence of photoactive particles, such as e.g. TiO₂ (anatase) or/and in the event of severe weathering. The coating thereby formed is often particularly adhesive or/and largely or completely closed.

Preferably, the total amount of liquid(s) is not removed during the drying, but it is advantageous if, for example, a content of liquid in the range of from 0.1 to 12 wt. %, based on the content of in particular inorganic non-coated particles, remains in the bulk powder. This is advantageous because the pores then cannot (yet) become smaller due to re-swelling of the conductive polymer.

If required, the coated inorganic particles can be ground briefly or/and ground with a gentle action in order to break up so-called cakes, agglomerates or/and, where appropriate, also aggregates-or/and to render them pourable. The conductive powders are optionally also sifted.

Preferably, the coated inorganic particles are first decanted, filtered or/and dried. The constituents which can be dissolved out can then be extracted from the conductive coating in a manner such that substantially no incorporated anions and substantially no oxidizing agent required for stabilizing the conductive polymer is dissolved out. By this means, the conductive stable structure of the conductive polymers and their conductivity state are left substantially unchanged. Excess oxidizing agent, which could react e.g. with a lacquer, and non-incorporated anions, unreacted monomers and oligomers and other impurities and other constituents which are not required can be removed during the extraction. The extraction can be carried out in particular with an acid aqueous solution, such as e.g. with sulfuric acid or hydrochloric acid, or/and with at least one organic solvent, such as e.g. acetonitrile, chloroform or/and methanol. This step can significantly improve the quality of the coating.

It has been found that after preparation of the core-shell particles, a stabilizer can sometimes advantageously be added, but is often not necessary. However, the addition of a stabilizer to an already stable product mixture is rather a disadvantage in some embodiment variants. On the other hand, an unstable product mixture, e.g. if the concentrations chosen were too high, in particular of the conductive polymer, can be stabilized by addition of a stabilizer.

Particles Coated With Conductive Polymer:

The object is furthermore achieved with inorganic or/and organic particles coated with conductive polymer, wherein the conductive polymer is substantially in the oxidized, electrically conductive state and wherein a content of mobile corrosion-protecting anions and optionally also a content of adhesion-promoting anions is incorporated into the conductive polymer, the particles preferably having been coated by a process according to the invention.

The contents of the constituents in the conductive coating can be varied within wide limits. The variation depends in particular on the thickness of the coating: Ultra-thin, thin, thick or very thick coatings which have a layer thickness in the range of from 0.1 to 10 nm, from >10 to 100 nm, from >100 nm to 1 μm or from >1 μm to 20 μm can be applied. Constituents having a low or high density can also be chosen. Furthermore, the specific surface area of the organic particles can influence very much, such as e.g. in the case of SiO₂ powders which have been prepared by flame hydrolysis.

Preferably, the content of conductive polymers in the conductive coating has values of about 50, 52, 54, 56, 58, 60, 62, 64, 66, 68, 70, 72, 74, 76, 78, 80, 82, 84, 86, 88, 90, 92, 94, 96, 98 or 100 wt. %, based on the coating. In particular, the content of conductive polymers in the conductive coating is in the range of from 48 to 100 wt. %, particularly preferably in the range of from 61 to 97 wt. %, very particularly preferably in the range of from 69 to 95 wt. %.

Preferably, the content of anions has values of about 10, 12, 14, 16, 18, 20, 22, 24, 26, 28, 30 or 32 mol %, based on the conductive polymer of the coating. Preferably the content of oxidizing agents, based on the coating, has values of 0, and as far as possible mo more. In particular, the content of anions in the conductive coating is in the range of from 8 to 35 mol %, particularly preferably in the range of from 15 to 33 mol %, often in the range of from 19 to 32 mol %.

Preferably, the content of particles in the content of particles including their coatings and intercalactions, based on conductive polymer, has values of about 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96 or 98 wt. %. In particular, the content of particles including their coatings and intercalations, based on conductive polymer, in the conductive coating of high binder content is in the range of from 5 to 100 wt. %, particularly preferably in the range of from 55 to 99 wt. %, very particularly preferably in the range of from 75 to 98 wt. %, above all in the range of from 85 to 97 wt. %.

Preferably, the average pore size of the conductive polymer to be formed is increased by increasing the swelling of the electrically conductive polymer to be formed, by addition of a readily vaporizable organic liquid, such as e.g. chloroform in the case of polythiophene or such as e.g. alcohol in the case of polypyrrole and in the case of some polypyrrole derivatives.

In spite of their low thickness, the coatings according to the invention are often significantly coloured. They are often light green to dark green, pale blue to dark blue, light grey to dark grey, light red to dark red, violet, brown or black in colour. The conductive polymers are often hydrophobic, but according to the type and amount can be more hydrophilic or more hydrophobic, depending on the anion content, oxidation state, pH and substitution of the side groups.

The electrical conductivity of the coating on particles which are covered with a coating comprising conductive polymer can be in the range of from 10⁻⁸ to 10⁰ S/cm, depending on the degree of oxidation, on the type of charge carriers or/and the charge carrier mobility, preferably in the range of from 10⁻⁶ to 10⁻¹ S/cm, particularly preferably in the range of from 10⁻⁵ to 10⁻² S/cm.

The degree of doping can be determined by elemental analysis or XPS (X-ray spectroscopy). It is conventionally in the range of from 5 to 33%, a degree of doping of higher than 28% being achieved in only some cases in practice. Degrees of doping in the range of from 20% to 33% are often achieved.

Preferably, the quality of the conductive coating is increased by establishing the maximum possible degree of doping of the conductive polymers with mobile corrosion-protecting anions, which leads to a high depot effect and often also to a sufficient electrical conductivity of the coating to be formed. In many uses an adequate electrical conductivity is sufficient, because too high an electrical conductivity possibly leads to the potential gradient being broken down too rapidly and the driving force for the migration of anions under certain circumstances decreasing or ending too rapidly (short circuit effect) for the anions to be able to display their corrosion protection action.

The coating comprising conductive polymer on the particles should preferably comprise no oxidizing agent or virtually no oxidizing agent, since this can be harmful for the corrosion protection action of the organic coating comprising coated particles. It is therefore advisable to remove excess oxidizing agent(s) from the product mixture, e.g. by dialysis, extraction or/and filtration.

The layer thickness of the conductive polymer on the particles can be varied within wide ranges. Preferably, the layer thicknesses are in the range of from 1 to 200 nm, particularly preferably in the range of from 2 to 100 nm, above all in the range of from 3 to 80 nm. Under certain circumstances, these layers are thinner in the case of inorganic particles than in the case of organic particles. Thicker layers are indeed conceivable and possible in principle, but could reach their limits when the coated particles can no longer be dispersed.

Preparation and Addition of So-Called “Adhesion Promoter Particles” of Conductive Polymer:

At least one so-called “adhesion promoter” based on conductive polymer, which can be prepared in particular by emulsion polymerization, can also be added to the mixture of high binder content. This is at least one depot substance having in each case at least one substituent per molecule which improves the adhesion to the metallic surface. In particular, the adhesion to the metal and binder matrix interface can thereby be improved and the corrosion protection increased. Since the “adhesion promoter” also always contains at least one mobile corrosion-protecting anion, in the event of a potential gradient as a result of damage to the coating a rapid short migration of such anions to the damaged region is possible, since after application of the coating which has a high binder content and still contains water to the metallic surface, the “adhesion promoters” diffuse in a targeted manner preferentially to the interface between the metal and binder matrix and are therefore adsorbed particularly close to the interface (interface-close depot). As a result, the “adhesion promoters” can become more concentrated close to the interface, while the conductively coated particles usually are distributed more or less uniformly over the layer thickness of the coating.

The at least one “adhesion promoter” can be prepared by targeted copolymerization of monomer(s)/oligomer(s) with monomer/oligomer units which are substituted by adhesive groups and are built up from the same monomer(s)/oligomer(s). The monomer(s)/oligomer(s) can be chosen from those based on benzene, furan, imidazole, naphthalene, phenanthrene, phenol, pyrrole, thiophene or/and thiophenol. The substituents can be chosen from alkanoic acids, such as e.g. carboxylic acids, from phosphonic acids, phosphoric acids, sulfonic acids and salts thereof having at least one unbranched alkyl chain of independently of one another at least 6 to 20 C atoms, wherein at least one double chain can also optionally be formed. Substituted monomers or/and substituted oligomers based on benzene, bipyrrole, furan, imidazole, naphthalene, phenanthrene, phenol, pyrrole, thiophene or/and thiophenol having at least one substitution independently of one another by at least one phosphonic acid are particularly preferred.

The “adhesion promoter” can be prepared separately from the preparation and coating processes described in this Application, by emulsion polymerization in an optionally particle-free mixture which usually comprises a water-alcohol mixture, at least one oxidizing agent—preferably those with at least one mobile corrosion-protecting anion having an oxidizing agent action at least partly instead of the separate oxidizing agent, at least one mobile corrosion-protecting anion, at least one monomer/oligomer and at least one monomer/oligomer which is/are substituted by adhesive groups and is/are built up from the same monomer(s)/oligomer(s). The emulsion polymerization preferably takes place at room temperature or at a slightly higher temperature and at a pH preferably in the range of from 2 to 4. By this means, substantially spherical particles of adjustable size which consist largely or entirely of doped conductive polymer are usually formed. These particles are conventionally readily dispersible. The dispersions prepared with them are as a rule stable, so that they do not have to be agitated and the particles also do not have to be redispersed.

These “adhesion promoter particles” can be incorporated into the binder-containing matrix in addition or as an alternative to the coated inorganic or/and organic particles. The amount of “adhesion promoter particles” added can be varied within wide limits, e.g. they are preferably added in amounts of from 0.01 to 20 wt. % of the composition having a high binder content, based on the solids contents, particularly preferably in amounts of from 0.1 to 10 wt. %, very particularly preferably from 1 to 5 wt. %.

Use of the Conductively Coated Particles:

The particles coated by the process according to the invention or the inorganic or/and organic particles coated with conductive polymer can be used for coating surfaces of metallic tapes, wires, profiles or parts for the purpose of corrosion protection, for coating surfaces to avoid antistatic charging or/and contamination, as electrode material in sensors, in batteries, as electrode material having catalytic properties, as a dielectric addition for conductive coatings and compositions, as filling material in electrical insulation, as a dyestuff or for conductor smoothing layers.

Particular Advantages and Surprising Effects of the Systems and Particles According to the Invention:

The processes according to the invention for the preparation of a conductive coating are particularly suitable for technical uses since with only very small amounts of the comparatively expensive educts large amounts of particles can be coated in quite simple process steps and with low expenditure on apparatus compared with very many other coating processes. In the processes of the prior art which lead to similar coatings, however, the addition of an adhesion promoter, such as e.g. a silane, the incorporation of a spacer, such as e.g. an alkyl chain, into the educt, the addition of stabilizers based on water-soluble polymers, such as e.g. hydroxymethylcellulose, or/and the addition of surfactant(s) to the mixture before the oxidation is advantageous, in contrast to the processes according to the invention, in order to improve the adhesion to the metallic surface. The introduction of an adhesion promoter into the mixture often presents problems according to the prior art, since a particular adhesion promoter must be developed for each particle type. An addition e.g. of surfactant(s) to the mixture before the oxidation is conventionally not necessary in the process according to the invention.

If powder of conductive polymer is introduced into an organic composition, such as e.g. into a lacquer or into a lacquer-like, predominantly or entirely organic coating, the colour of the powder particles without a light-coloured core is significantly more intense, and as an additive to an organic coating composition can impart an undesirable colour impression or a mottled effect or a shot effect to the coating formed therefrom. The electrical conductivity of the coatings produced in this way may be non-uniform and therefore provide an incomplete, namely locally differing good or poor corrosion protection: The percolation threshold beyond which the conductivity path exists is higher in this case.

Surprisingly, it was possible to demonstrate not only the release and migration of the anions from the conductive polymer to the corroding region and the hoped-for corrosion protection action of the coatings according to the invention in very specific experiments, such as e.g. with a scanning Kelvin probe (SKP), but also the concentration of the corrosion-protecting anions released in the corroding region and a significant increase in the corrosion protection of metallic substrates with an organic coating comprising conductive polymer in the macroscopic range with samples and experiments relevant in practices, such as e.g. in the salt spray test.

Surprisingly, the process for coating inorganic or organic particles was particularly simple, reproducible and environment-friendly. It was possible in this context to coat several kilograms of particles with a few cubic centimetres of educt mixture.

Surprisingly, it has now been found that a coating of nanoparticles proceeded particularly successfully, namely with a high degree of coating and largely without agglomeration. On the other hand, it was also possible to coat relatively coarse particles surprisingly well with the process according to the invention, since a homogeneous, often closed coating was formed on these particles, in spite of their size and their difficult dispersibility.

Surprisingly, it was possible to distribute the conductive polymer particularly easily, uniformly and in a stable manner in a composition of high binder content with the aid of the particles comprising conductive polymer, in particular in film formation.

Surprisingly, the choice of anions which can be incorporated in the case of chemical polymerization of the conductive polymers is almost unlimited.

Surprisingly, the particles coated with conductive polymer were stable during storage in a liquid medium in wide pH ranges and were also more stable than expected in this, so that no deactivation of the conductive polymer was observed.

Surprisingly, the particles comprising conductive polymer have an exceptional mechanical stability, and their shells adhere very well to the particles, so that even during ultrasound treatments no damage was perceived and no or no substantial damage was observed even in the case of longer-lasting deposition of the conductive polymers on particles in the mixture under the action of ultrasound.

Furthermore, it was surprising that it was possible for coated particles which settled or gelled out of the initially stable dispersion on to the base of the vessel during their storage to be redispersed again and then, without disadvantages, to be introduced into a substantially organic dispersion of a lacquer-like composition and incorporated later into a substantially organic coating.

### EXAMPLES AND COMPARISON EXAMPLES

The examples described in the following are intended to illustrate the subject matter of the invention in more detail by way of example.

1. Preparation Path of the Conductive Polymers and Coating of Inorganic Particles with Variation in the Composition of the Mixture:

The preparation of the conductive polymers and simultaneously the coating of the inorganic particles were carried out in a one-pot process at a temperature which was kept constant in each case in the range of from 50 to 60° C. over the reactions.

The educt mixture was prepared by adding to 100 ml distilled water first isopropanol and in each case 10 to 15 g of a powder chosen from Al₂O₃, BaSO₄, CaCO₃, CuO, SiO₂, SnO₂, TiO₂ as anatase or rutile, ZnO, coarsely crystalline biotite mica, treated montmorillonite, quartz-rich sea sand, potter's clay and in addition also pretreated cellulose powder suitable for column chromatography, while stirring. 0.1 to 0.5 ml concentrated sulfuric acid was then added in order to adjust the pH to values in the range of from 4 to 6, this acid serving at the same time as a solubilizing agent for molybdic acid and monomer/oligomer. Thereafter, 0.3 ml of the monomer/oligomer, dissolved in 20 to 50 ml isopropanol at room temperature, was added. The educt was in each case one chosen from pyrrole, N-methylpyrrole and ethylenedioxythiophene. After a stirring time of from 15 to 20 minutes, an aqueous molybdic acid solution (H₂MoO₄), preheated to the mixture temperature, of from 1.5 to 3 g/l having a content of about 20% isopropanol was added. The mixture was stirred during the entire reaction time. After a further stirring time in the range of from 30 to 150 minutes, the coated inorganic particles and the particles of conductive polymer which were formed in the dispersion were separated off from excess solvent mixture and oxidizing agent by filtration. Thereafter the particles were dried at 60 to 80° C. for 20 to 30 minutes in a drying cabinet, as a result of which a dry filter cake formed. The filter cake was pounded in a mortar and ground substantially homogeneously for 10 to 15 minutes. Alternatively, a ball mill was employed in some cases. The ground material comprised completely and partly coated inorganic particles, isolated residues of the coating shell, particles of conductive polymer and non-coated inorganic particles (particle mixture). It was estimated under a light microscope that in each case about 85 to 95% of the visible particles were conductively coated particles. In principle, it was possible in this context to employ inorganic particles having an average particle size in the range of from 5 nm to 5 mm. The inorganic particles were not ground down or were ground down to only a small extent during the grinding, depending on their nature. In the case of particles of greater than about 100 to 200 nm, the particle distributions of the inorganic particles were in a wide particle distribution range, below virtually monodisperse. Only the particles under about 100 nm were substantially spherical. The coating on the particles had a layer thickness in the range of from 2 to 10 nm, observed under a transmission electron microscope. The contents of conductive polymer were determined by thermogravimetry and were in the range of from 3 to 10 wt. % of the dry particle mixture. An electrical conductivity and therefore an increased doping was achieved in each experiment. The coating of the conductive polymers on the particles (core-shell particles) adhered well so that the coating also was not abraded off or ground off rapidly, even in an ultrasound bath. A large number of experiments were carried out, a small proportion of which is reproduced with the data in Table 1.

In addition, in supplementary experiments the particle mixture was introduced into an entirely anhydrous ethanolic solution or into an ethyl acetate solution and dispersed in an ultrasound bath, in order then to suspend two metal sheets in this dispersion and to precipitate the coated conductive particles on the cathode metal sheet via cataphoresis as in a cathodic electro-dipcoating under a voltage in the range of from 10 to 100 V at a current intensity in the range of from 2 to 20 mA over a period of from 1 to 5 minutes. For the metallic bodies to be coated, cataphoresis did not represent a risk of corrosion on the basis of the cataphoresis—in contrast to anaphoresis or electropolarization. A very uniform, thin, adhesive, coating, in some cases complete on both sides, of the metal sheets with the particle mixture thereby resulted. Thereafter, the coated metal sheets were dried. The layer thicknesses were estimated at values in the range of from 2 to 15 μm. This coating on the metal sheets was significantly better than if the particle mixture were to have been spread on e.g. as a dispersion. The structure of the coating on the metal sheets is substantially determined by the morphology of the coated particles incorporated. In this context, it was surprising that the conductive polymer did not deteriorate in its properties—in particular its electrical conductivity, its chemical and thermal stability and its corrosion protection properties—in all stages of the in some cases somewhat drastic treatment.

TABLE 1
Compositions of the mixtures with inorganic particles and properties of the coatings

| Contents in μl, ml or g | E 1 | E 2 | E 3 | E 4 | E 5 | E 6 | E 7 | E 8 | E 9 | E 10 | E 11 |
|---|---|---|---|---|---|---|---|---|---|---|---|
| Pyrrole in μl | 300 | 300 | 300 | 300 | 300 | 300 | 300 | 300 | | | |
| Ethylenedioxythiophene in μl | | | | | | | | | 300 | 300 | 300 |
| Benzoate in g | 6 | | | | | | | | | | |
| Nitrosalicylate in g | | 6 | | | | | | 3 | | | |
| Hexafluorotitanate in g | | | 6 | | | | | | | | |
| Salicylate in g | | | | 6 | | 6 | | | | | |
| Tartrate in g | | | | | 6 | | 6 | | | | |
| Molybdate* in g | | | | 3 | 3 | | | 2 | 3 | 3 | 3 |
| Tungstate* in g | | | | | | 3 | 3 | | | | |
| Ce⁴⁺ sulfate in g | 3 | | | | | | | | | | |
| Fe³⁺ nitrate in g | | 3 | | | | | | | | | |
| Fe³⁺ sulfate in g | | | 3 | | | | | | | | |
| Al₂O₃C, Degussa, 12 nm, in g | 15 | 15 | 15 | 15 | 15 | 15 | 15 | 15 | 15 | 15 | 15 |
| Isopropanol in ml | 100 | 100 | 100 | 100 | 100 | 100 | 100 | 100 | 100 | | 100 |
| Dist. water in ml | 150 | 150 | 150 | 150 | 150 | 150 | 150 | 150 | 150 | 250 | 200 |
| PH | 4-6 | 4-6 | 4-6 | 4-6 | 4-6 | 4-6 | 4-6 | 4-6 | 4-6 | 4-6 | 4-6 |
| Temperature in ° C. | 40-60 | 40-60 | 40-60 | 40-60 | 40-60 | 40-60 | 40-60 | 40-60 | 40-60 | 40-60 | 40-60 |
| Electrical conductivity in S/cm | n.d. | 10⁻² | n.d. | n.d. | n.d. | n.d. | n.d. | n.d. | n.d. | n.d. | n.d. |
| Colour | blue | blue | grey | grey | grey- | grey | grey- | grey- | grey- | grey- | grey- |
| | | | | | blue | | blue | blue | blue | blue | blue |

*Anions having an oxidizing agent action

2. Preparation Path and Coating of Organic Particles with Variation in the Composition of the Mixture:

An aqueous educt mixture with all the constituents, including the organic particles and optionally a salt which has no oxidizing properties but the anion of which has corrosion-protecting properties, optionally also with the addition of from 1 to 10 wt. % ethanol, for the preparation of the conductive polymer—with the exception of the oxidizing agent—was first prepared at room temperature. The particular compositions are shown in Table 2. If the salt had oxidizing properties and the anion of the salt had corrosion-protecting properties, the salt was instead added only after the homogenizing. If molybdate or tungstate was used as the oxidizing agent, the educt mixture was heated to a temperature of 5° C. before the addition of the molybdate or tungstate if the pH was above 3. The pH was established with phosphoric acid. The educt mixture was stirred for approx. 20 minutes at this temperature in order to render possible intensive mixing of the constituents, since otherwise a phase separation could have occurred. Good homogeneity of the solution (educt mixture) had to have already existed on addition of the oxidizing agent.

The organic particles employed were polystyrene, polystyrene/butyl acrylate or polybutyl acrylate of defined compositions and glass transitions temperatures T_{g}, which were added as aqueous dispersions. The organic particles had almost monodisperse particle size distributions and were largely spherical. It was possible to choose the average particle size distribution between 150 and 500 nm, both the glass transition temperature T_{g} and the chemical composition having been varied at each of these distributions.

TABLE 2
Compositions of the mixtures with organic particles and properties of the coatings

| Contents in ml or g | E 21 | E 22 | E 23 | E 24 | E 25 | E 26 | E 27 | E 28 | E 29 | E 30 | E 31 | E 32 | E 33 | E 34 |
|---|---|---|---|---|---|---|---|---|---|---|---|---|---|---|
| Dist. water in ml | 100 | 100 | 100 | 100 | 100 | 100 | 100 | 100 | 100 | 100 | 100 | 100 | 100 | 100 |
| Ethanol in ml | 1 | 3 | 5 | 10 | | | | | 5 | 5 | 5 | 5 | 5 | 5 |
| Isopropanol in ml | | | | | 1 | 3 | 5 | 10 | | | | | | |
| Pyrrole in g | 0.1 | 0.5 | 1.5 | 5 | 0.1 | 0.5 | 1.5 | 5 | | | | | | |
| N-Methylpyrrole in g | | | | | | | | | 1.5 | | | | | |
| 3-Methoxypyrrole in g | | | | | | | | | | 1.5 | | | | |
| 3-Methylpyrrole in g | | | | | | | | | | | 1.5 | | | |
| 3-Ethylpyrrole in g | | | | | | | | | | | | 1.5 | | |
| 3-Phenylpyrrole in g | | | | | | | | | | | | | 1.5 | |
| Ethylenedioxythiophene in g | | | | | | | | | | | | | | 1.5 |
| Benzoate in g | 3.0 | 3.0 | 3.0 | 3.0 | 3.0 | 3.0 | 3.0 | 3.0 | 3.0 | 3.0 | 3.0 | 3.0 | 3.0 | 3.0 |
| NH₄S₂O₈ in g | 0.1 | 0.5 | 1.5 | 5 | 0.1 | 0.5 | 1.5 | 5 | 1.5 | 1.5 | 1.5 | 1.5 | 1.5 | 1.5 |
| Polystyrene in g | 10 | 10 | 10 | 10 | 10 | 10 | 10 | 10 | 10 | 10 | 10 | 10 | 10 | 10 |
| Average particle size in nm | 300 | 300 | 300 | 300 | 300 | 300 | 300 | 300 | 300 | 300 | 300 | 300 | 300 | 300 |
| Glass trans. temp. T_{g} of particles ° C. | 100 | 100 | 100 | 100 | 100 | 100 | 100 | 100 | 100 | 100 | 100 | 100 | 100 | 100 |
| pH | 3 | 3 | 3 | 3 | 3 | 3 | 3 | 3 | 3 | 3 | 3 | 3 | 3 | 3 |
| Temperature in ° C. | 25 | 25 | 25 | 25 | 25 | 25 | 25 | 25 | 25 | 25 | 25 | 25 | 25 | 25 |
| Size of the organic coated particles in nm | 305 | 310 | 315 | 320 | 305 | 310 | 315 | 320 | 315 | 315 | 315 | 315 | 315 | 315 |
| Electrical conductivity in S/cm | 10⁻⁶ | 10⁻⁵ | 10⁻⁴ | 10⁻³ | 10⁻⁶ | 10⁻⁵ | 10⁻⁴ | 10⁻³ | n.d. | n.d. | n.d. | n.d. | n.d. | n.d. |
| Degree of doping approx. in % | 30 | 30 | 30 | 30 | 30 | 30 | 30 | 30 | n.d. | n.d. | n.d. | n.d. | n.d. | n.d. |

| Contents in ml or g | E 35 | E 36 | E 37 | E 38 | E 39 | E 40 | E 41 | E 42 | E 43 | E 44 | E 45 | E 46 | E 47 | E 48 | E 49 |
|---|---|---|---|---|---|---|---|---|---|---|---|---|---|---|---|
| Dist. water in ml | 100 | 100 | 100 | 100 | 100 | 100 | 100 | 100 | 100 | 100 | 100 | 100 | 100 | 100 | 100 |
| Ethanol in ml | 5 | 5 | 5 | 5 | 5 | 5 | 5 | 5 | 5 | 5 | 5 | 5 | 5 | 5 | 5 |
| Isopropanol in ml | | | | | | | | | | | | | | | |
| Pyrrole in g | 1.5 | 1.5 | 1.5 | 1.5 | 1.5 | 1.5 | 1.5 | 1.5 | 1.5 | 1.5 | 1.5 | | | | 1.5 |
| N-Methylpyrrole in g | | | | | | | | | | | | 1.9 | 1.9 | 1.9 | |
| Molybdate* in g | | 1.65 | 3.30 | 10.2 | 13.6 | 20.3 | 10.2 | 10.2 | 10.2 | 10.2 | 10.2 | 10.2 | 13.6 | 20.3 | 10.2 |
| Tungstate* in g | 3.3 | | | | | | | | | | | | | | |
| Polystyrene in g | 10 | 10 | 10 | 10 | 10 | 10 | | | | | | | | | |
| Polystyrene/butyl acrylate in g | | | | | | | 10 | 10 | 10 | 10 | 10 | 10 | 10 | 10 | |
| Polybutyl acrylate in g | | | | | | | | | | | | | | | 10 |
| Styrene:butyl acrylate ratio | | | | | | | 9:1 | 5:1 | 2:5 | 3:5 | 4:5 | 3:5 | 3:5 | 3:5 | |
| Average particle size in nm | 300 | 300 | 300 | 300 | 300 | 300 | 300 | 300 | 300 | 300 | 300 | 300 | 300 | 300 | 300 |
| Glass trans. temp. T_{g} of particles ° C. | 100 | 100 | 100 | 100 | 100 | 100 | 80 | 60 | 40 | 20 | −10 | 20 | 20 | 20 | −40 |
| pH | 2 | 2 | 2 | 2 | 2 | 2 | 2 | 2 | 2 | 2 | 2 | 2 | 2 | 2 | 2 |
| Temperature in ° C. | 25 | 25 | 25 | 25 | 25 | 25 | 25 | 25 | 25 | 25 | 25 | 25 | 25 | 25 | |
| Size of the organic coated particles | 315 | 315 | 315 | 315 | 315 | 315 | 315 | 315 | 315 | 315 | 315 | 315 | 315 | 315 | 315 |
| in nm | | | | | | | | | | | | | | | |
| Electrical conductivity in S/cm | n.d. | n.d. | n.d. | n.d. | n.d. | n.d. | n.d. | n.d. | n.d. | n.d. | n.d. | n.d. | n.d. | n.d. | n.d. |
| Degree of doping approx. in % | 17 | 15 | 19 | 23 | 27 | 30 | 23 | 23 | 23 | 23 | 23 | 18 | 21 | 24 | 23 |

| Contents in ml or g | E 50 | E 51 | E 52 | E 53 | E 54 | E 55 | E 56 | E 57 |
|---|---|---|---|---|---|---|---|---|
| Dist. water in ml | 100 | 100 | 100 | 100 | 100 | 100 | 100 | 100 |
| Ethanol in ml | 5 | 5 | 5 | 5 | 5 | 5 | 5 | 5 |
| Pyrrole in g | 1.5 | 1.5 | 1.5 | 1.5 | 1.5 | 1.5 | 1.5 | 1.5 |
| Molybdate* in g | 3.41 | 3.41 | 3.41 | 3.41 | | | | |
| Tungstate* in g | | | | | 3.30 | 3.30 | 3.30 | 3.30 |
| Polystyrene/butyl acrylate in g | 10 | 10 | 10 | 10 | 10 | 10 | 10 | 10 |
| Styrene:butyl acrylate ratio | 3:5 | 3:5 | 3:5 | 3:5 | 3:5 | 3:5 | 3:5 | 3:5 |
| Average particle size in nm | 300 | 300 | 300 | 300 | 300 | 300 | 300 | 300 |
| Glass trans. temp. T_{g} of particles ° C. | 20 | 20 | 20 | 20 | 20 | 20 | 20 | 20 |
| PH | 1 | 3 | 4 | 5 | 1 | 3 | 4 | 5 |
| Temperature in ° C. | 25 | 25 | 50 | 50 | 25 | 25 | 50 | 50 |
| Size of the organic coated particles in nm | 315 | 315 | 315 | 315 | 315 | 315 | 315 | 315 |
| Electrical conductivity in S/cm | n.d. | n.d. | n.d. | n.d. | n.d. | n.d. | n.d. | n.d. |
| Degree of doping approx. in % | 28 | 28 | 28 | 28 | 28 | 28 | 28 | 28 |

*Anions having an oxidizing agent action

The average particle size of the non-coated and coated organic particles was determined under a scanning electron microscope. The electrical conductivity was determined on the interdigital structures (comb-like electrodes) with the aid of the two-point method on pressed pieces of doped conductive powder. All the conductively coated organic particles were black.

Among the educt solutions, those with pyrrole and N-methylpyrrole proved suitable in particular, these particularly advantageously having been applied to organic particles based on polystyrene/butyl acrylate in the ratio of from 50 to 90 wt. % styrene content. Molybdate or tungstate in particular showed advantageous properties as the oxidizing agent and simultaneously as anions. In the case of molybdate and tungstate, it proved to be important that almost maximum doping of the conductive polymer is possible and advantageous at up to about 28%, based on the polymer unit.

In Examples E21 to E28, the layer thickness of the coating of conductive polymers was also increased with the increasing content of pyrrole, from about 5 nm to 10 nm. In Example E 34, a thiophene was used instead of pyrrole. In Example 35, in contrast to E 23, tungstate was added. In Examples E 36 to E 40, in contrast to E 23 and E 35, molybdate was employed. The concentration of the mobile corrosion-protecting anions here is higher and as a result the depot action is better. In Examples E 41 to E 48, the film formability of the particles was changed due to the variation in the composition of the organic particles: In E 43 and E 44 the film formability is best, while the film formability was no longer so easily controllable at glass transition temperatures T_{g} of below 20° C. if the temperature at which the procedure was carried out was not below room temperature. In Examples E 50 to E 57, the pH and the oxidizing agent were varied, better results being achieved at pH values of 4 and 5 for molybdate and at pH 5 for tungstate. In respect of the mobility of the mobile corrosion-protecting anions, Examples E 52, E 53 and E 57 should show the best mobility of the anions, since these anions are particularly small and at higher pH values the tendency towards formation of large polyanions is lower.

3. Preparation Path and Coating of Organic Particles with Variation of the Oxidizing Agent

In these examples, the procedure was substantially as for the 2nd preparation path.

The educt solution was prepared in first working steps by first adding to 50 ml distilled water a total of 50 g of an aqueous dispersion of polystyrene or/and polybutyl acrylate having a content of 20 wt. % of such organic particles of about 350 nm average size, and 1.4 g freshly distilled pyrrole. In further experiments, pyrrole was exchanged for N-methylpyrrole. The solution was stirred for 20 minutes in order to homogenize the mixture at room temperature.

An oxidizing agent solution was then prepared by dissolving in 50 ml water 0.1 to 1 mol oxidizing agent, such as a) phosphomolybdate or b) H₂O₂ with ≦10⁻⁴ molar Fe³⁺ chloride with H₂O₂ in excess. This solution was then added dropwise, after homogenization of the educt solution. The mixture formed was then stirred at room temperature for 4 to 6 hours. Polypyrrole coatings approx. 10 nm thick were formed on the organic particles in the dispersion by this means. Moreover, before addition of the oxidizing agent, in a) the anion of the oxidizing agent was intercalated as a doping ion into the polypyrrole or into a corresponding derivative, while in b) before addition of the oxidizing agent in each case any desired corrosion-protecting mobile anion (molybdate, hexafluorotitanate, hexafluorozirconate, tungstate) was additionally added to the educt mixture.

The reaction mixture was then dialysed for 48 hours over a cellulose membrane of 10,000 MWCO against doubly distilled water in order to separate off unreacted educts, oxidizing agent and anions. The particles were provided with coatings in the range of from 5 to 20 nm thick. The dispersions obtained in this way were stable and usable for longer than six months.

4. Preparation Path with the Preparation of “Adhesion Promoter Particles” Based on Conductive Polymers:

At room temperature, an aqueous educt mixture containing 5% ethanol and based on monomer/oligomer substituted with adhesive groups with monomer/oligomer which is built up from the same monomer/oligomer, namely pyrrole, was prepared in aqueous solution. An unbranched alkylphosphonic acid having 10 or having 12 C atoms was used as the adhesive groups. In this context, a salt of the mobile corrosion-protecting anion, ammonium molybdate, was added to the solution. The molybdate served simultaneously as the oxidizing agent. The mixture was stirred throughout the entire time. The procedure was carried out at pH values in the range of from 2.5 to 4, the pH being established via the content of alkylphosphonic acid. The pKₐ value of the adhesion-promoting groups determines the pH of the educt mixture and renders possible a micelle formation of the monomer/oligomer substituted by adhesive groups in the mixture. The emulsion polymerization was carried out over 10 to 24 hours, while stirring. The dispersion was purified by dialysis in order to obtain an alcohol-containing aqueous dispersion of the “adhesion promoter particles” largely free from excess anions and entirely free from oxidizing agent and unreacted monomer/oligomer. The dispersion contained substantially spherical “adhesion promoter particles”, the particle size distribution of which was virtually monodisperse and of which it was possible to adjust the average particle size as desired in the range of from 50 to 400 nm.

1-59. (canceled)

60. A process comprising coating particles, wherein said particles ar organic or inorganic, and wherein the particles are present in a mixture or are initially formed in this, wherein the educt mixture is at least one of a dispersion, a flowable a kneadable mass, a sol or a gel, wherein the educt mixture;, comprises:
at least one of a monomer or at least one oligomer—in the following called “educt(s) of the conductive polymer” or merely “educt(s)”
chosen from monomers or oligomer of aromatics or unsaturated hydrocarbon compounds which are suitable for formation of electrically conductive oligomer/ polymer/ copolymer/ block copolymer/ graft copolymer therefrom,
at least one type of anion, optionally at least one salt, one ester or at least one acid as a carrier of these anions
wherein this at least one type of anions in the conductive polymer can be incorporated or is incorporated into the structure of the conductive polymer as a doping ion, can also be released again from this structure in the event of a drop in potential of the conductive polymers (reduction) and if a metallic surface is present, can have a corrosion-protecting action—in the following called “mobile corrosion-protecting anions”,
at least one type of particles selected from the group consisting of clusters, nanoparticles, nanotubes, fibrous, convoluted or porous structures, particles having an average particle size in the range of from 10 nm to 10 mm and accumulations thereof, such as agglomerates or aggregates, and
water or at least one other polar solvent and optionally at least one further solvent,
wherein a coating having a thickness of at least one monolayer is formed from the educt mixture on at least a part of the surfaces of the particles, the coating comprising either a substantial content of monomers or oligomers, alongside, where appropriate, at least one further component of the educt mixture, or a substantial content of conductive polymer,
wherein in the dispersion, in the mass, in the sol or gel or—optionally at least after separating off some of the liquid—in an aerosol at least apart of the monomers or oligomers is reacted by oxidation chemically with at least one oxidizing agent, electrochemically under an electrical voltage or photochemically under the action of electromagnetic radiation, in each case in the
presence of at least one type of mobile corrosion-protecting anions before during or after coating of the particles, at least partly to give at least one oligomer or optionally partly or completely to give in each case at least one polymer, copolymer, block copolymer or graft copolymer in a mixture comprising water or at least one other polar solvent (“product(s)”),
wherein the oligomers, polymers, copolymers, block copolymers or graft copolymers formed by this means—in the following called “conductive polymers”—are at least partly electrically conductive or become more electrically conductive.

61. A process comprising coating inorganic or organic particles, in which the particles ate present in a mixture or are initially formed in this, wherein the mixture is a dispersion, a flowable or kneadable mass, a sot or a gel, wherein the mixture is a product mixture and comprises:
at least one electrically “conductive polymer” based on an oligomer/polymer/copolymer/block copolymer/graft copolymer,
at least one type of anions—optionally at least one salt, one ester or at least one acid as a carrier of these anions
wherein this at least one type of anions in the conductive polymer can be incorporated or is at least partly incorporated into the structure of the conductive polymer as a doping ion, can also be released again from this structure in the event of a drop in potential of the conductive polymer (reduction) and if a metallic surface is present, can have a corrosion-protecting action—in the following called “mobile corrosion-protecting anions”,
at least one type of particles chosen from clusters, nanoparticles, nanotubes, fibrous, convoluted or porous structures, particles having an average particle size in the range of from 10 nm to 10 mm and accumulations thereof, such as agglomerates or aggregates, and
optionally oxidizing agents, water or at least one other solvent,
wherein a coating having a thickness of at least one monolayer is formed from the product mixture on at least part of the surfaces of the particles,
wherein the oligomers, polymers, copolymers, block copolymers or graft copolymers formed—in the following called “conductive polymers”—are at least partly electrically conductive or become more electrically conductive.

62. A process according to claim 60, wherein when mixing together the constituents, the mixture is free from oxidizing agents until at least a monolayer of the educt or educts has formed on at least a part of the surfaces of the inorganic or organic particles.

63. A process according to claim 60, wherein when mixing together the constituents, the mixture is kept free from the educts of the conductive polymers until at least a monolayer of at least one mobile corrosion-protecting anion and, where appropriate, oxidizing agent(s) has formed on at least a part of the surfaces of the particles.

64. A process according to claim 60, wherein at least one anion which does not act as an oxidizing agent is added to the mixture before or during formation of the monolayer.

65. A process according to claim 60, wherein the educt mixture or product mixtures comprises:
optionally at least one monomer or at least one oligomer with a content of educt(s) in the range of from 0.001 to 20 wt. %,
at least one mobile corrosion-protecting anion or at least one salt, one ester or at least one acid as a carrier of this anion., with a content of mobile corrosion-protecting anions in the range of from 0.05 to 50 wt. %, calculated as anion(s),
optionally at least one oxidizing agent with a content of oxidizing agents in the range of from 0.05 to 50 wt. %,
at least one type of inorganic or organic particles with a content of particles in the range of from 1 to 95 wt. %,
wherein all these contents and optionally further additions not mentioned here, but without solvent, give 100 wt. % in total, and
at least one solvent for the educts, for the anions or for the oxidizing agents with contents of solvents in the range of from 1 to 5,000 wt. %, stated above 100 wt. %,
wherein the sum of the solids is 100 wt. % when—optionally later—monomer/oligomer or oxidizing agent has been added.

66. A process according to claim 60, wherein the educt mixture or product mixture has the following composition:
optionally 0.001 to 0.5 mol/l of at least one monomer or of at least one oligomer of the educt mixture, as long as high concentrations do not lead to agglomerations of the coated particles,
0.01 to 1 mol/l of at least one mobile corrosion-protecting anion, optionally at least one salt, one ester or at least one acid as a carder of this anion, in each case calculated as the anion,
optionally at least one oxidizing agent in one to five times the amount of the content of educts,
1 to 96 wt. % of inorganic or organic particles, preferably in each case of at least one chemical compound,
wherein all these contents and optionally fiercer additions not mentioned here, but without solvent, give 100 wt. % in total when—optionally later—monomer/oligomer or oxidizing agent has been added, and
at least one solvent for the educts, for the anions or for the oxidizing agents with contents in the range of from 2 to 4,000 wt. %, stated above 100 wt. %.

67. A process according to claim 60, whercin the educt mixture or product mixture has the following composition:
optionally at least one monomer or at least one oligomer with a content of educt(s) in the range of 1 to 25 wt. %,
at least one mobile corrosion-protecting anion or at least one salt, one ester or at least one acid as a carrier of this anion with a content of mobile corrosion-protecting anions in the range of from 1 to 35 wt. %,
optionally at least one oxidizing agent with a content of oxidizing agents in the range of from 1 to 40 wt. %, and
at least one type of inorganic or organic particles with a content of particles in the range of from 35 to 95 wt. %.

68. A process according to claim 60, wherein the educt mixture or product mixture has the following composition:
optionally at least one monomer or at least one oligomer with a content of educt(s) in the range of from 0.5 to 18 wt. %,
at least one mobile corrosion-protecting anion with a content of mobile corrosion-protecting anions in the range of from 0.5 to 35 wt. %,
optionally at least one oxidizing agent with a content of oxidizing agents in the range of from 0.2 to 30 wt. %, and
at least one type of inorganic or organic particles with a content of particles in the range of from 10 to 40 wt. %.

69. A process according to claim 60, wherein the product mixture has the following composition:
at least one conductive polymer with a content of product(s) in the range of from 1 to 25 wt. % and
at least one type of inorganic or organic particles with a content of particles in the range of from 35 to 95 wt. %.

70. A process according to claim 60, wherein the inorganic particles substantially comprise at least one inorganic substance substantially from in each case at least one boride, carbide, carbonate, cuprate, ferrate, fluoride, fluorosilicate, niobate, nitride, oxide, phosphate, phosphide, phosphosilicate, selenide, silicate, sulfate, sulfide, telluride, titanate, zirconate, at least one type of carbon, at least one alloy, at least one metal, mixed crystals, mixtures or intergrowths thereof.

71. A process according to claim 60, wherein the inorganic particles substantially comprise at least one substance, in particular substantially in each case at least one alkaline earth metal carbonate, alkaline earth metal titanate, alkaline earth metal zirconate, SiO₂, aluminum-containing silicate, mica, clay mineral, zeolite, flakes based on SiO₂ or silicate(s), oxide(s) having a content of aluminum, iron, calcium, copper, magnesium, titanium, zinc, tin or zirconium.

72. A process according to claim 60, wherein the organic particles comprising conductive polymer are predominantly or entirely those which are chosen from the group consisting of polymers based on styrene, acrylate, methacrylate, polycarbonate, cellulose, polyepoxide, polyimide, polyether, polyurethane, siloxane, polysiloxane, polysilane and polysilazanes.

73. A process according to claim 60, wherein before a liquid is added or before addition to the mixture, the particles are ground, dried or calcined.

74. A process according to claim 60, wherein the monomers or oligomers are chosen from monomers or oligomers of heterocyclic compounds where X═N or S which are suitable for formation of electrically conductive oligomer/polymer/copolymer/block copolymer/graft polymer therefrom.

75. A process according to claim 60, wherein the monomers o oligomers are chosen from unsubstituted or substituted compounds based on imidazole, naphthalene, phenanthrene, pyrrole, thiophene or thiophenol.

76. A process according to claim 60, wherein unsubstituted or substituted compounds are chosen from monomers or oligomers based on bithiophenes, terthiophenes, alkylthiophenes, ethylentedioxythiophene, alkylpyrroles or polyparaphenylene.

77. A process according to claim 60, wherein the monomer/oligomer chosen is at least one compound from benzimidazoles, 2-alkylthiophenols, 2-alkoxythiophenols, 2,5-dialkylthiophenols, 2,5-dialkoxythiophenols, 1-alkylpyrroles, 1-alkoxypyrroles, 3-alkylpyrroles, 3-alkoxypyrroles, 3,4-dialkylpyrroles, 3,4-dialkoxypyrroles, 1,3,4-trialkylpyrroles, 1,3,4-trialkoxypyrroles, 1-arylpyrroles, 3-arylpyrroles, 1-aryl-3-alkylpyrroles, 1-aryl-3-alkoxypyrroles, 1-aryl-3,4-dialkylpyrroles, 1-aryl-3,4-dialkoxypyrroles, 3-alkylthiophenes, 3-alkoxythiophenes, 3,4-dialkylthiophenes, 3,4-dialkoxythiophenes, 3,4-ethylenedioxythiophene and derivatives thereof.

78. A process according to claim 60, wherein the substitution of the monomers or oligomers and of the oligomers, polymers, copolymers, block copolymers or graft copolymers being formed/formed therefrom is by hydrogen, hydroxyl, halogen., alkoxy, alkyl, carboxy, carboxylate, amine, amino, amide, primary ammonium, imine, imide phosphonate, diphosphonate, mercapto, sulfone, sulfonate, aryl or unbranched or branched alkyl chains without or with further substituents.

79. A process according to claim 60, wherein educt:(s) having a relatively loose molecular structure is/are added to the mixture or at least one of the conductive polymer formed has a relatively loose molecular structure, which leads/lead to a larger average pore size of the pore systems of the conductive polymer.

80. A process according to claim 60, whereon educt(s) which are water-soluble and which preferably are no longer or only slightly water-soluble after their oxidation is/are added to the mixture.

81. A process according to claim 60, wherein productus based on polyethylene, polyfuran, polyimidazole, polyphenanthrene, polypyrrole, polythiophene or polythiophenylene which are loaded or can be loaded with at least one type of anions are formed in the mixture.

82. A process according to claim 60, wherein at least one anion is chosen from anions based on carboxylic acids, hydroxycarboxylic acids, oxycarboxylic acids, dicarboxylic acids, tricarboxylic acids, di- or tri-substituted arenecarboxylic acids, meta-, ortho- or para-substituted arenecarboxylic acids, arenoic acids containing amino, nitro, SO₃H (sulfone) or OH groups, sulfonic acids, mineral oxy-acids, boron-containing acids, manganese-containing acids, molybdenum-containing acids, phosphorus-containing acids, phosphonic acids, fluorosilicic acids, silicas, acids having a content of at least one clement of the rare cars or yttrium, sulfur-containing acids, titanium-containing acids, vanadium-containing acids, tungsten-containing acids, tin-containing acids, zirconium-containing acids, salts thereof, esters thereof and mixtures thereof.

83. A process according to claim 60, wherein at least one anion is chosen from anions based on alkyl-phosphonic acids, aryl-phosphonic acids, benzoic acid, succinic acid, tetrafluorosilicic acid, hexafluorotitanic acid, hexafluorozirconic acid, gallic acid, hydroxyacetic acid, silicas, lactic acid, molybdic acids, niobic acid, nitrosalicylic acids, oxalic acid, phosphomolybdic acid, phosphoric acid, phosphosilicic acid, phthalic acids, salicylic acid, tantalic acid, vanadic acids, tartaric acid, tungstic acids, salts thereof, esters thereof and mixtures thereof.

84. A process according to claim 60, wherein the at least one mobile corrosion-protecting anion, such as e.g. TiF₆²⁻; ZrF₆²⁻, CeO₄⁴⁻, MnO₄⁻, MnO₄²⁻, MoO₄²⁻, MoO₄⁴⁻, VO₄²⁻, WO₄²⁻ or WO₄⁴⁻, undergoes an exchange of ligands, change in valency or change in solubility and forms an oxidic protective layer in the region of the defect or in the region of the delamination front.

85. A process according to claim 60, wherein at least one anion is chosen from those based on carboxylate, complex fluoride, molybdate, nitro compound, phosphorus-containing oxyanions, polysiloxane, silane, siloxane or surfactant.

86. A process according to claims 60, wherein at least one anion has a diameter which is not larger than the average pore size of the pore system of the conductive polymer, wherein this diameter preferably is at least 8% smaller than the average pore size of the pore system.

87. A process according to claim 60, wherein the electrical conductivity of the coating to be formed is increased by increasing the concentration of the at least one anion in the conductive polymer.

88. A process according to claim 60, wherein the electrical conductivity of the coating to be formed is increased by the addition of at least one anion which can assume various vacancy levels and which changes easily into other valency levels.

89. A process according to claim 60, wherein anions which additionally have a corrosion protection action on the metallic surface for a metallic surface which is optionally to be protected and is coated with a coating which comprises coated inorganic particles.

90. A process according to claim 60, wherein anions which additionally have a delamination-inhibiting action on the metallic surface for a metallic surface which is optionally to be protected and is coated with a coating which comprises coated inorganic particles.

91. A process according to claim 60, wherein the electrical conductivity of the coating to be formed is increased by increasing the concentration of the oxidizing agent, of the educt/educts or by the addition of at least one anion of suitable anion size.

92. A process according to claim 60, wherein at least one oxidizing agent based on H₂O₂, such as e.g. barium peroxide, peracetic acid, perbenzoic acid, permanganic acid, peroxomonosulfuric acid, peroxodisulfuric acid, Lewis acid, molybdic acid, niobic acid, tantalic acid, titanic acid, tungstic acid, zirconic acid, yttrium-containing acid, lauthanide-containing acid, Fe³⁺-containing acid, Cu²⁺-containing acid, salts thereof, esters thereof or mixtures thereof, is added.

93. A process according to claim 60, wherein at least one compound based on acid(s), the salt(s) of which can exist in several valency levels, or at least one compound based on peroxide(s) or per-acid(s) is employed as the oxidizing agent.

94. A process according to claim 60, wherein the at least one liquid added is those solvents which are liquid in the temperature range of from 0 to 200° C., 2 to 160° C. or 5 to 95° C.

95. A process according to claim 60, wherein the at least one liquid added is at least one chosen from dipolar aprotic, dipolar protic and non-polar liquids.

96. A process according to claim 60, wherein the at least one liquid is at least one chosen from acetonitrile, chloroform., ethanol, isopropanol, methanol, propanol, toluene, ethyl acetate and water.

97. A process according to claim 60, wherein the average pore side of the conductive oligomer, polymer, copolymer or graft copolymer to be formed is increased by increasing the swelling of the electrically conductive polymer to be formed by addition of a readily vaporizable organic liquid.

98. A process according to claim 60, wherein at least one oligomer, polymer, copolymer, block copolymer or graft copolymer which is chosen from compounds based on poly(1-alkylpyrrole) (P1APy), poly(1-alkoxypyrrole) (P1AOPy), poly(3-alkylpyrrole) (P3APy), poly(3-alkoxypyrrole) (P3AOPy), poly(1-arylpyrrole) (P1ArPy), poly(3-arylpyrrole) (P3ArPy), poly(3-alkylthiophene) (P3ATH, poly(3-alkoxythiophene) (P3ATH), poly(3-arylthiophene) (P3ArTH), poly(3-alkylbithiophene), poly(3,3′-dialkylbithiophene), poly(3,3′-dialkoxybithiophene), poly(alkylterthiophene), poly(alkoxythiophene), poly(3,4-ethylenedioxythiophene) (PEDOT) and poly(benzo[b]thiophene (PBTH) is prepared or added to the composition as the product.

99. A process according to claim 60, wherein the average pore size of the conductive oligomer, polymer, copolymer or graft copolymer to be formed is increased by establishing a relatively high temperature during the formation of the coating or during the drying of the mixture.

100. A process according to claim 60, wherein additives are added to the mixture, optionally at least one surfactant, at least one protective colloid, at least one acid-trapping agent or at least one complexing agent.

101. A process according to claim 60, wherein at least one stabilizer chosen from water-soluble polymers based on polyvinyl alcohol, polyvinyl alkyl ether, polystyrenesulfonate, polyethylene oxide, polyalkylsulfonate, polyarylsulfonate, anionic or cationic surfactants, quaternary ammonium salts and tertiary amines is added to the mixture.

102. A process according to claim 60, wherein the mixture is dried by decanting, filtering or freeze drying, in particular by spin drying with filtering, or by gas circulation or heat, in particular at temperatures of up to 200° C. or preferably of up to 150° C. or of up to 120° C.

103. A process according to claim 60, wherein during the during the total amount of liquid is not removed, but a liquid content in the range of from 0.1 to 12 wt. %, based on the content of inorganic non-costed particles, is retained.

104. A process according to claim 60, wherein the coated inorganic particles are ground briefly or ground with a gentle action in order to break tip so-called cakes, agglomerates or optionally also aggregates or to render them pourable, or are sifted.

105. A process according to claim 60, wherein the inorganic particles are first decanted, filtered or dried and the constituents which can be dissolved out are subsequently extracted from the conductive coating in a manner such that substantially no incorporated anions and substantially no oxidizing agent required for the conductive polymer for stabilization are dissolved out.

106. A process according to claim 60, wherein the particles coated with conductive polymer are provided with a further coating.

107. A process according to claim 60, wherein the particles coated with conductive polymer are introduced into an organic or organic mass or dispersion.

108. A mixture for coating particles, having a composition according to claim 60.

109. A mixture according to claim 108, comprising
at least one monomer or oligomer with a content of educts in the range of from 0.1 to 30 wt. %,
at least one anion with a content of anions in the range of from 0.1 to 40 wt. %,
optionally at least one oxidizing agent with a content of oxidizing agents in the range of from 0.1 to 30 wt. %,
at least one type of inorganic or organic particles with a content of particles in the range of from 30 to 98 wt. %,
wherein all these contents and optionally further additions not mentioned here, but without solvent, give 100 wt. % in total, and
at least one solvent for the educts or for the anions or oxidizing agent with contents in the range of from 1 to 4,000 wt. %, stated beyond 100 wt. %.

110. A mixture according to claim 108, comprising
at least one monomer or oligomer with a content of educts in the range of from 0.5 to 18 wt. %,
at least one anion with a content of anions in the range of from 0.5 to 35 wt. %,
optionally at least one oxidizing agent with a content of oxidizing agents in the range of from 0.2 to 30 wt. %, and
at least one type of inorganic or organic particles with a content of particles in the range from 10 to 40 wt. %.

111. A mixture according to claim 108, comprising
at least one monomer or oligomer with a content of educts in the range of from 1 to 25 wt. %,
at least one anion with a content of anions in the range of from 1 to 35 wt. %,
optionally at least one oxidizing agent with a content of oxidizing agents in the range of from 0.1 to 40 wt. % and
at least one type of inorganic particles with a content of inorganic particles in the range of from 35 to 95 wt. %.

112. A composition of a coating comprising conductive polymer comprising
at least one oligomer, polymer, copolymer, block copolymer or graft copolymer with a content of conductive polymers in the range of from 0.1 to 30 wt. %,
at least one anion with a content of anions in the range of from 0.1 to 40 wt. %, which is at least partly incorporated into the conductive polymer,
optionally at least one oxidizing agent and
at least one type of particles with a content of in particular inorganic particles in the range of from 30 to 98 wt. %,
wherein all these contents, including optionally further additions not mentioned here, but without solvent, give 100 wt. % in total, and
optionally at least one solvent in particular for the products, anions or oxidizing agents with contents in the range of from 0.1 to 4,000 wt. %, stated above 100 wt. %,

113. Particles coated with conductive polymer. wherein the conductive polymer is substantially in the oxidized, electrically conductive state and a content of mobile corrosion-protecting anions and optionally also a content of adhesion-promoting anions is incorporated in the conductive polymer, wherein the particles are organic or inorganic.

114. Inorganic or organic particles coated with conductive polymer, prepared according to claim 60.

115. Inorganic or organic particles coated with conductive polymer, which have a coating having a composition according to claim 112.

116. Inorganic or organic particles coated with conductive polymer, which have a coating based on conductive polymer with anions containing titanium or zirconium.

117. A coating surface comprising the particles of claim 113.

118. A surface having a coating comprising the coated particles of claim 113.
